(19) United States
(12) Patent Application Publication
(10) Pub. No.: US 2012/0204484 A1
(43) Pub. Date: Aug. 16, 2012

(54) PLANT ENCLOSURE THAT OFFERS PEST CONTROL

(76) Inventor: GREGORY GRINBERG, San Mateo, CA (US)

(21) Appl. No.: 13/370,448

(22) Filed: Feb. 10, 2012

Related U.S. Application Data
(60) Provisional application No. 61/441,653, filed on Feb. 11, 2011.

(51) Int. Cl. A01G 9/02; A01G 13/02

(52) U.S. Cl. 47/20.1; 47/66.1

(57) ABSTRACT

An enclosure for plants that protects plants against pests and other living organisms that may be harmful to plants. In one embodiment, a pot includes a first open-top container and a second open-top container. The first open-top container forms a first open space for housing a plant and includes an open top and an enclosed wall portion that forms a lateral perimeter of the first open-top container. The second open-top container forms a second open space for housing a pest-controlling substance that deters or attracts and traps pests. The second open-top container is coupled to the first open-top container along the lateral perimeter of the first open-top container. Additionally, the first open space is isolated from the second open space to prevent contents in the first open space from mixing with contents from the second open space.

### CROSS-REFERENCE TO RELATED APPLICATION

This application claims the benefit of U.S. Provisional Patent Application No. 61/441,653, entitled “A DEVICE TO PROTECT THE CONTENTS OF CONTAINERS FROM VARIOUS FLIGHTLESS CREATURES BY PROVIDING A TRAP-BEARING PERIMETER THAT WILL ENSNARE, REPEL, DETER OR KILL SAID CREATURES,” which was filed on Feb. 11, 2011, the entire disclosure of which is hereby incorporated by reference herein.

### FIELD OF DISCLOSURE

The present disclosure is generally related to gardening enclosures for plants, and, more specifically, to gardening enclosures that protect the plants from pests and/or other living organisms that may be harmful to plants.

### BACKGROUND

Effective and efficient control of common garden pests, insects, and other living organisms that may be harmful to the garden is a known challenge in gardening. Various solutions have been introduced to prevent plant-harming living organisms from harming plants. However, all of these solutions have some undesirable side effects or other shortcomings. For example, chemical pesticides are often used to deal with pests, but such pesticides are often expensive and ineffective. Moreover, pesticides present environmental and health risks (e.g., to gardeners, nearby children, pets, and so on). Another conventional solution for dealing with plant-harming living organisms is construction of greenhouses, but greenhouses are also generally expensive and potentially harmful for the environment. In addition, greenhouses typically require a tremendous amount of space.

### SUMMARY

The present disclosure provides enclosures for plants that protect the plants against pests and/or other living organisms that may be harmful to plants.

In one embodiment, a pot includes a first open-top container and a second open-top container. The first open-top container forms a first open space for housing a plant and includes an open top and an enclosed wall portion that forms a lateral perimeter of the first open-top container. The second open-top container forms a second open space for housing a pest-controlling substance that deters or attracts and traps pests. The second open-top container is coupled to the first open-top container along the lateral perimeter of the first open-top container. Additionally, the first open space is isolated from the second open space to prevent contents in the first open space from mixing with contents from the second open space.

In various implementations, one or more of the following features may be included. The pot may further include a roof element that may be coupled to the first open-top container along the lateral perimeter of the first open-top container and positioned above the second open-top container to limit entry of substances other than the pest-controlling substance into the second open-top container. The roof element may extend inward and upward from the enclosed wall portion of the first open-top container. Alternatively, or additionally, the roof element may extend outward and downward from the enclosed wall portion of the first open-top container. A vertical gap between the second open-top container and the roof element is between one (1) and sixteen (16) centimeters.

The first open-top container may include a drainage system. The drainage system may include at least one opening in the enclosed wall portion of the first open-top container to allow at least some contents of the first open-top container to drain out of the first open-top container via the at least one opening. The drainage system may be positioned above the roof element to limit entry into the second open-top container of contents draining out of the first open-top container.

The second open-top container may be coupled to the first open-top container or at the top of the first open-top container (e.g., near the open top of the first open-top container) or at the bottom of the first open-top container. For the purpose of stackability, at least a portion of the first open-top container and at least a portion of the second open-top container may together outline a frustum of the same cone or pyramid. Although a frustum is one way to ensure stackability, a frustum is not necessary for the pot to be stackable.

In another embodiment, a pot includes a hollow body and an open-top container. The hollow body forms an open space for housing a plant and includes an open top and an enclosed wall portion that forms a lateral perimeter of the hollow body. The open-top container forms an open space for housing a pest-controlling substance that deters or attracts and traps pests. The open-top container is coupled to the hollow body along the lateral perimeter of the hollow body. Additionally, the hollow body is isolated from the open-top space to prevent contents in the hollow body from mixing with contents from the open space.

In various implementations, one or more of the following features may be included. The pot may further include a roof element that may be coupled to the hollow body above the open-top container to limit entry of substances other than the pest-controlling substance into the open-top container. The roof element may extend inward and upward from the enclosed wall portion of the hollow body. Alternatively, or additionally, the roof element may extend outward and downward from the enclosed wall portion of the hollow body. A vertical gap between the open-top container and the roof element is between one (1) and sixteen (16) centimeters.

In another embodiment, a tray for housing a plant pot includes a first open-top container and a second open-top container. The first open-top container forms a first open space for housing a pot and includes an open top and an enclosed wall portion that forms a lateral perimeter of the first open-top container. The second open-top container forms a second open space for housing a pest-controlling substance that deters or attracts and traps pests. The second open-top container is coupled to the first open-top container along the lateral perimeter of the first open-top container. Additionally the first open space is isolated from the second open space to prevent contents in the first open space from mixing with contents from the second open space.

In various implementations, one or more of the following features may be included. The tray may include a roof element that may be coupled to the first open-top container along the lateral perimeter of the first open-top container and positioned above the second open-top container to limit entry of substances other than the pest-controlling substance into the second open-top container. The roof element extends outward and downward from the enclosed wall portion of the first open-top container. A vertical gap between the second open-top container and the roof element is between one (1) and sixteen (16) centimeters.

The tray may include a floor section for holding the pot, the floor section may include at least one raised surface which can be made to be in contact with the pot when the pot is put in the first open-top container. The raised surface covers or raised surfaces cover only a portion of the floor section, so that contents that drain out of the pot into the first open-top container can be collected in more or more areas of the floor section that are not covered by the raised surface or surfaces.

### BRIEF DESCRIPTION OF THE DRAWINGS

FIG. 1A illustrates a perspective view of a pot with a roof element extending inward from the enclosed wall portion of the plant container;

FIG. 1B illustrates a top-down view of a pot with a roof element extending inward from the enclosed wall portion of the plant container;

FIG. 1C illustrates a side view of a pot with a roof element extending inward from the enclosed wall portion of the plant container and a pest approaching the pot;

FIG. 1D illustrates a side view of a pot with a roof element extending inward from the enclosed wall portion of the plant container and a pest trapped in the trap container;

FIG. 1E illustrates a perspective view of a pot with a roof element extending inward from the enclosed wall portion of the plant container and a cone demonstrating stackability;

FIG. 2A illustrates a perspective view of a pot with a trap container coupled to the upper part of the enclosed wall portion of the plant container;

FIG. 2B illustrates a side view of a pot with a trap container coupled to the upper part of the enclosed wall portion of the plant container and a pest approaching the pot;

FIG. 2C illustrates a side view of a pot with a trap container coupled to the upper part of the enclosed wall portion of the plant container and a pest trapped in the trap container;

FIG. 2D illustrates a perspective view of a pot with a roof element extending outward from the enclosed wall portion of the plant container;

FIG. 3A illustrates a perspective view of a hollow body pot with a roof element extending inward from the enclosed wall portion of the plant container;

FIG. 3B illustrates a side view of a hollow body pot with a roof element extending inward from the enclosed wall portion of the plant container;

FIG. 3C illustrates a side view of a hollow body pot with a roof element extending inward from the enclosed wall portion of the plant container and a pest approaching the pot;

FIG. 3D illustrates a side view of a hollow body pot with a roof element extending inward from the enclosed wall portion of the plant container and a pest trapped in the trap container;

FIG. 3E illustrates a perspective view of a pot with a roof element extending inward from the enclosed wall portion of the plant container and a cone demonstrating stackability;

FIG. 4A illustrates a side view of a tray with a roof element extending outward from the enclosed wall portion of the open-top container and a pest trapped in the trap container;

FIG. 4B illustrates a side view of a tray with a roof element extending outward from the enclosed wall portion of the open-top container;

FIG. 4C illustrates a side view of a tray with a roof element extending outward from the enclosed wall portion of the open top container and a pest approaching the pot;

FIG. 4D illustrates a top-down view of a tray with a roof element extending outward from the enclosed wall portion of the open-top container;

FIG. 4E illustrates a perspective view of a tray with a roof element extending outward from the enclosed wall portion of the open-top container.

### DETAILED DESCRIPTION

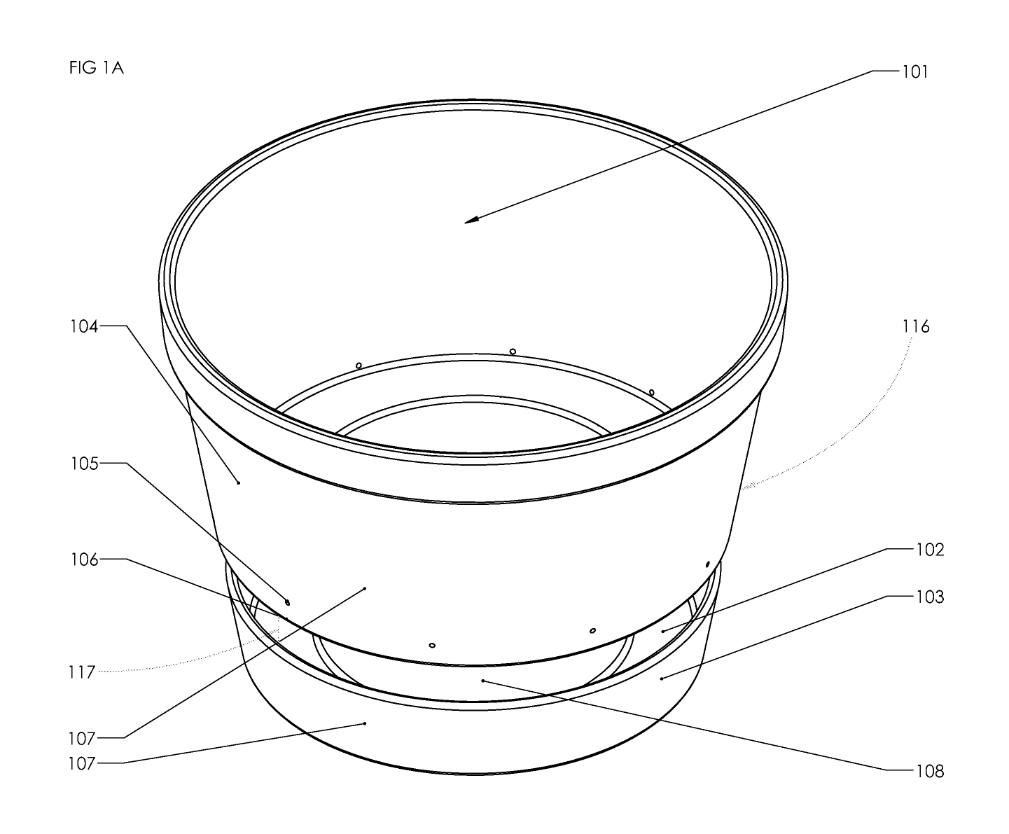

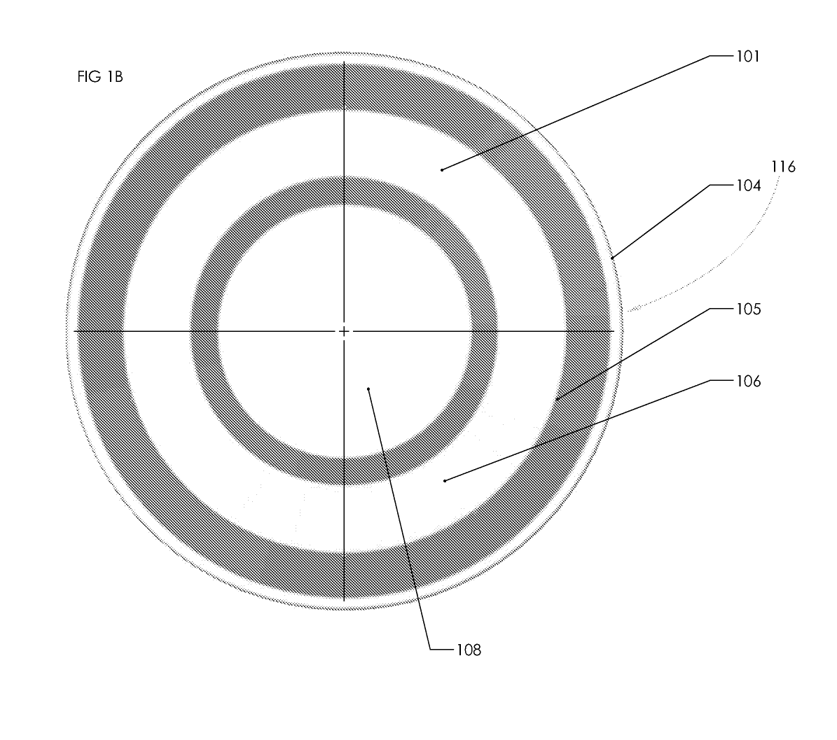

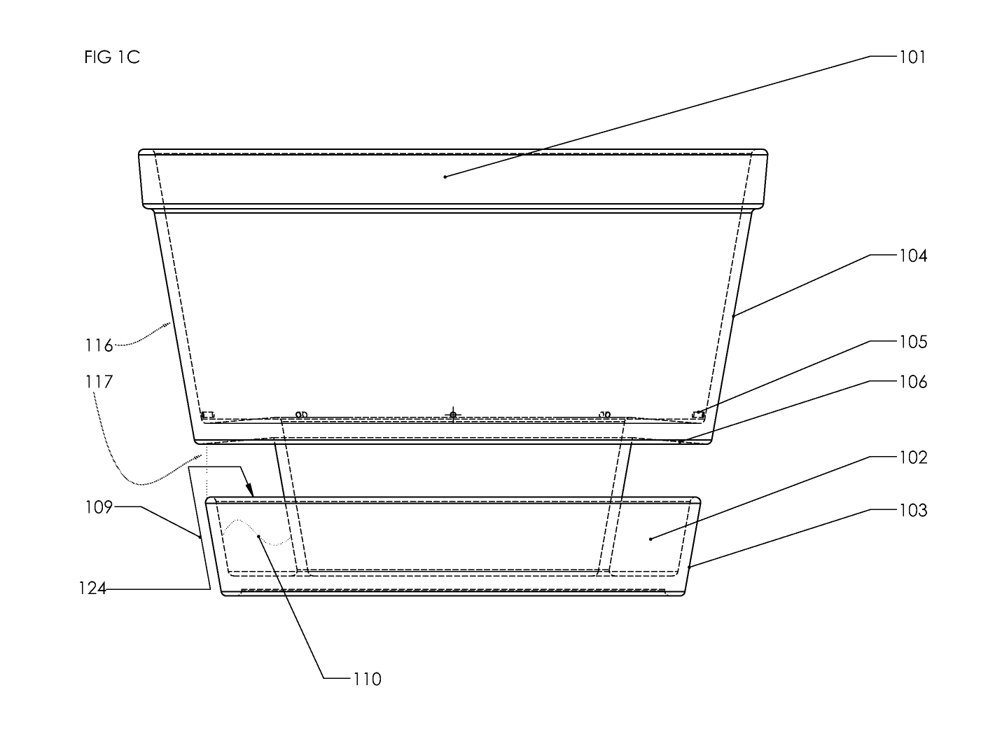

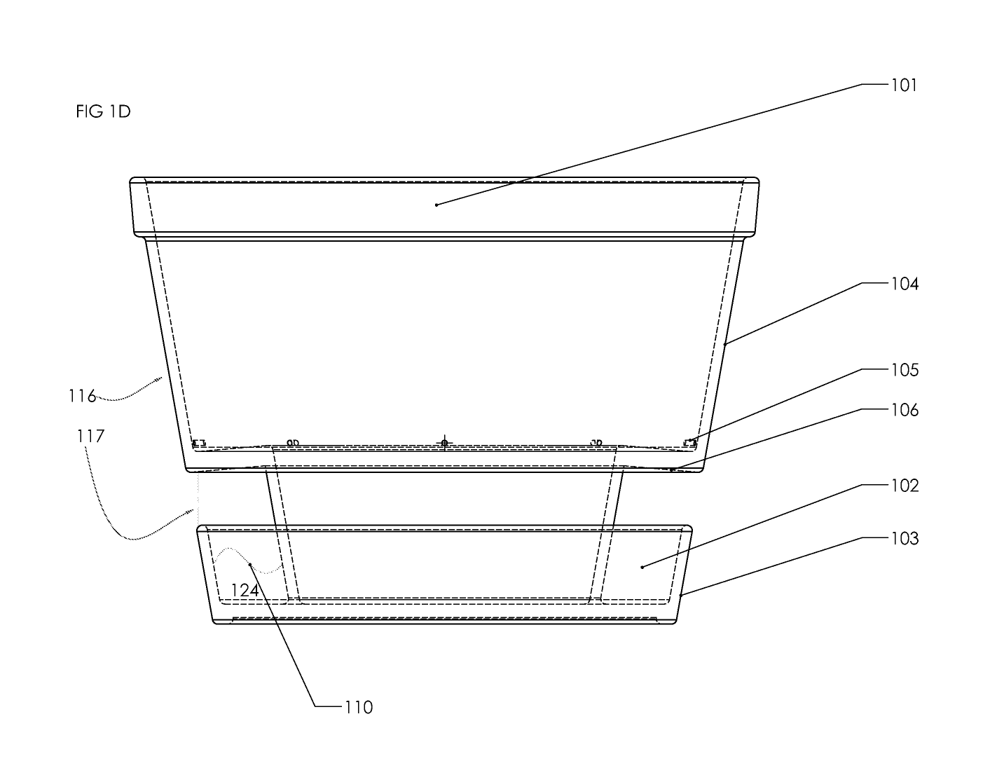

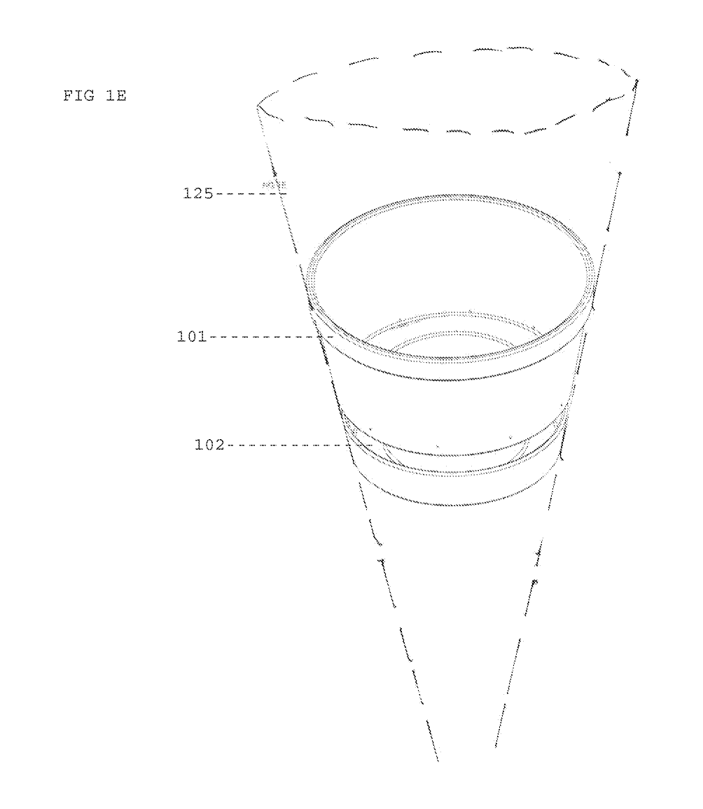

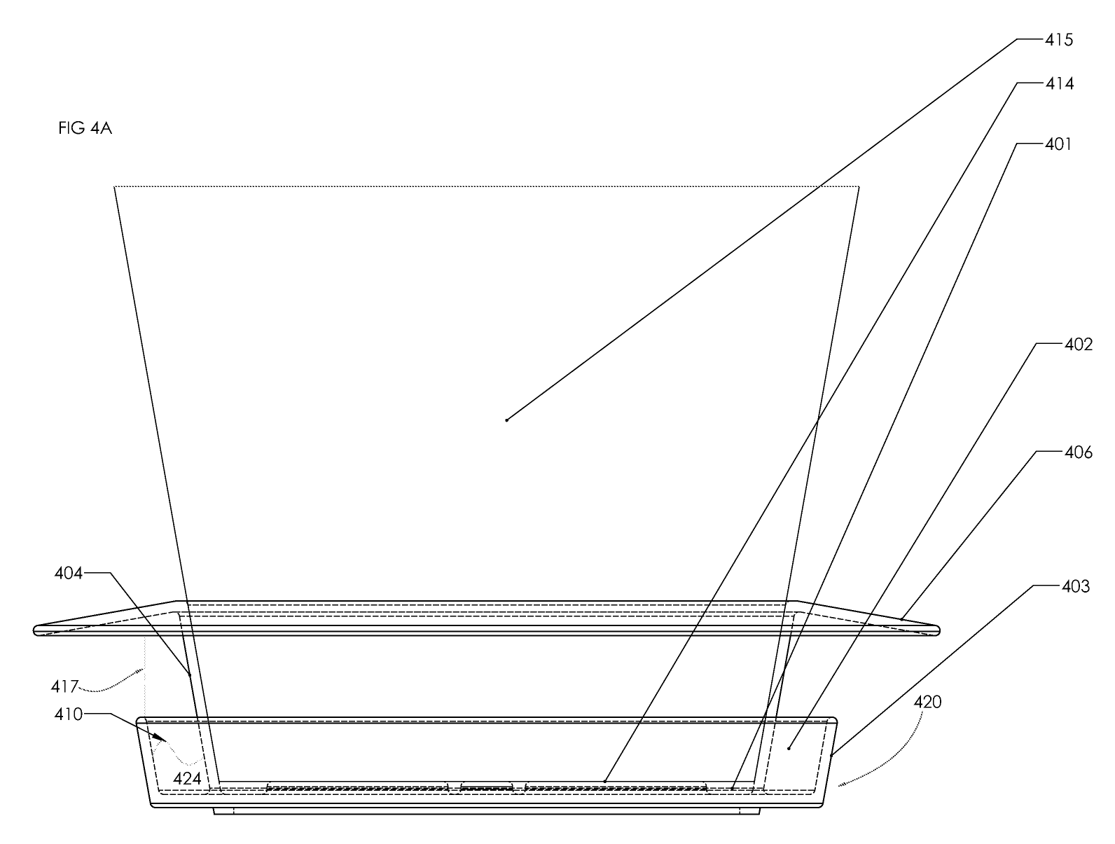

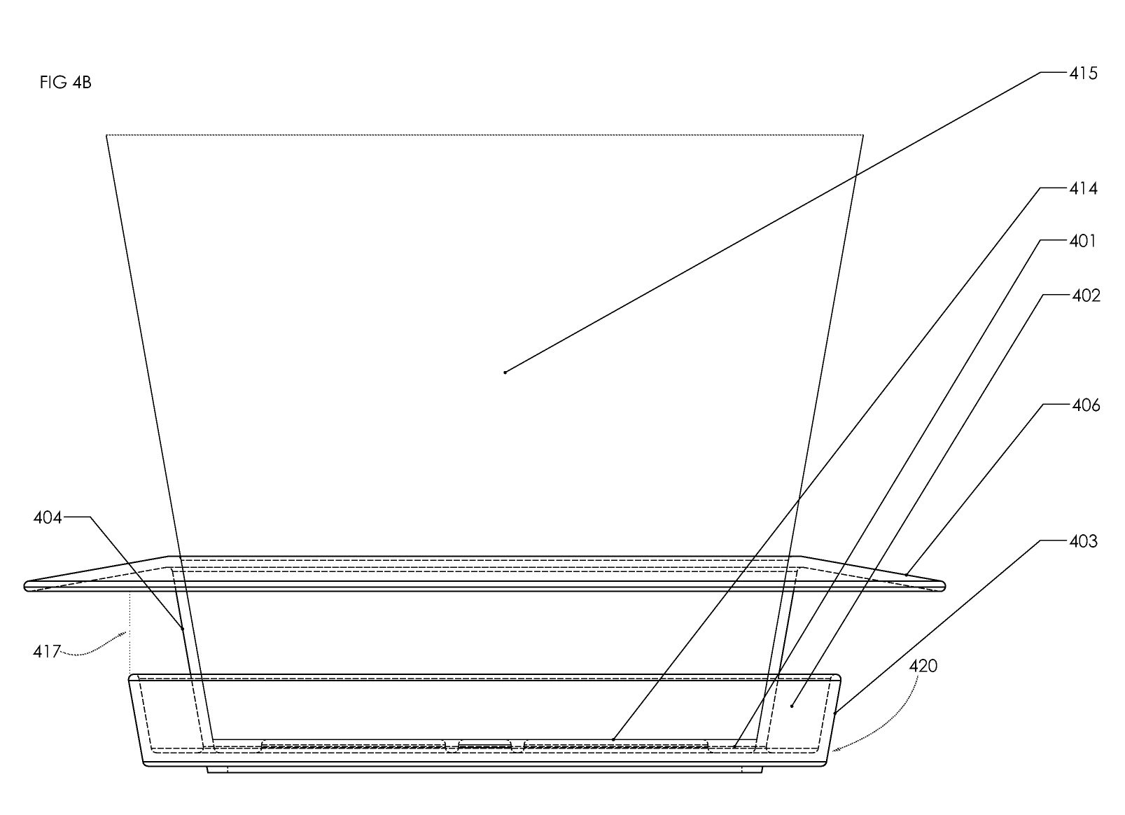

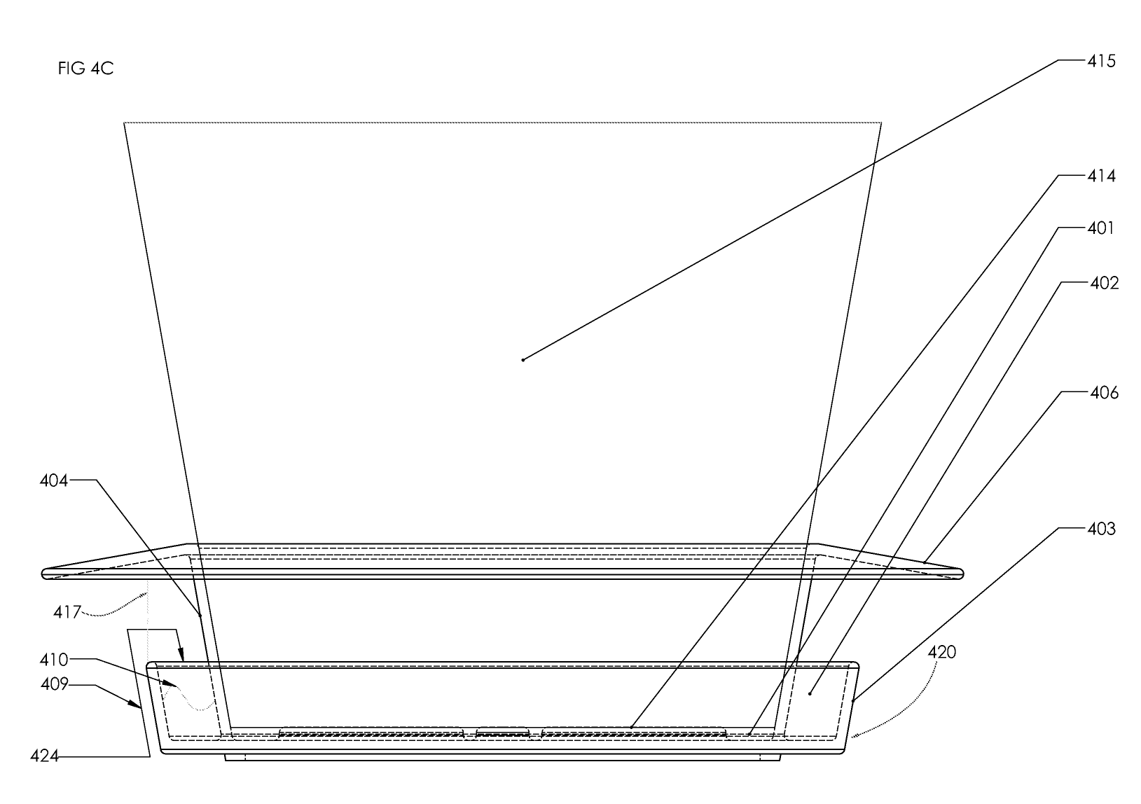

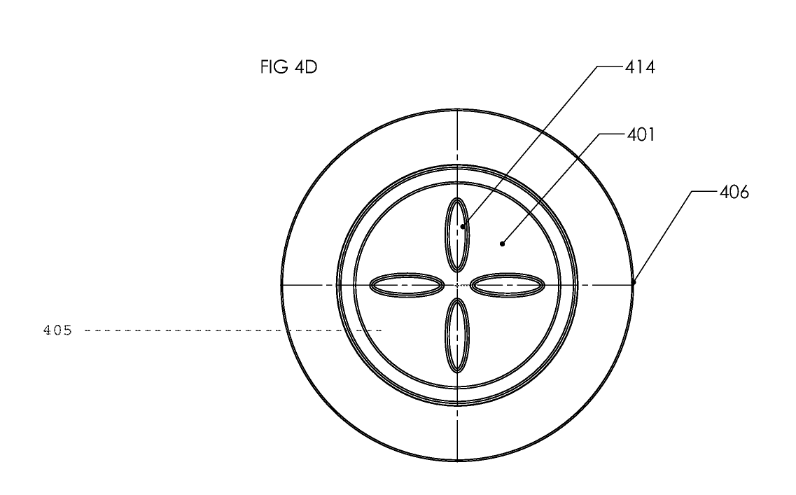

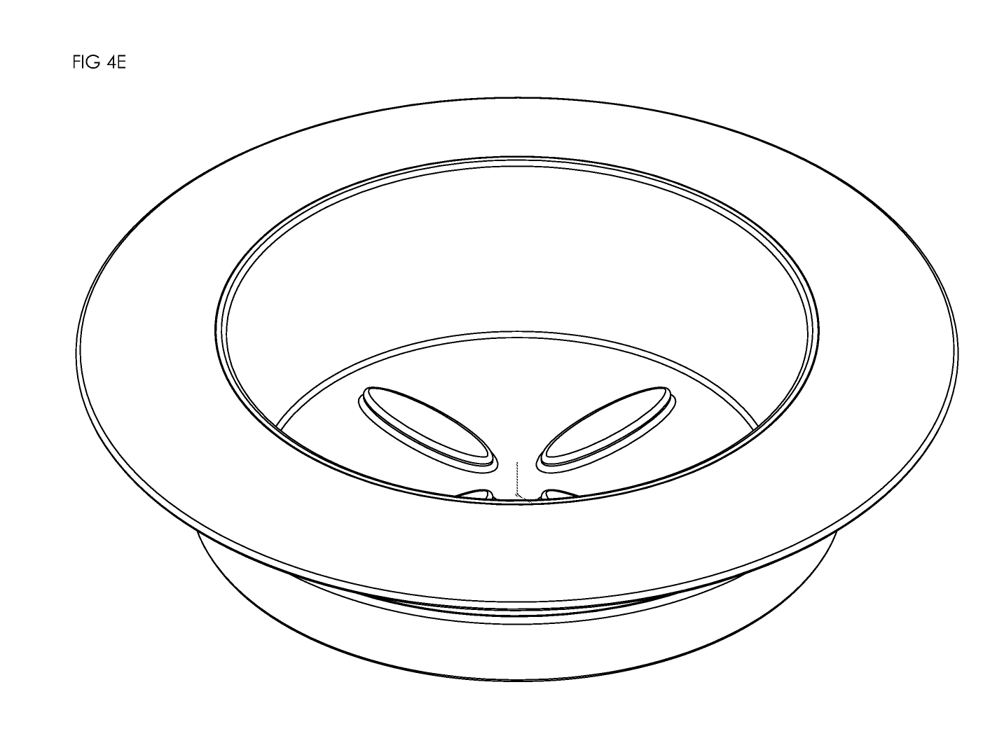

The present disclosure is generally related to gardening enclosures for plants, and, more specifically, to gardening enclosures that protect the plants from pests and/or other living organisms that may be harmful to plants. A number of embodiments will be described in reference to FIGS. 1A-4D. In particular, several embodiments of a gardening pot will be described in reference to FIGS. 1A-3E, and several embodiments of a tray for a gardening pot will be described with respect to FIGS. 4A-4D. Of course, the different embodiments described in this disclosure are to be construed as exemplary only and do not describe every possible embodiment since describing every possible embodiment would be impractical, if not impossible.

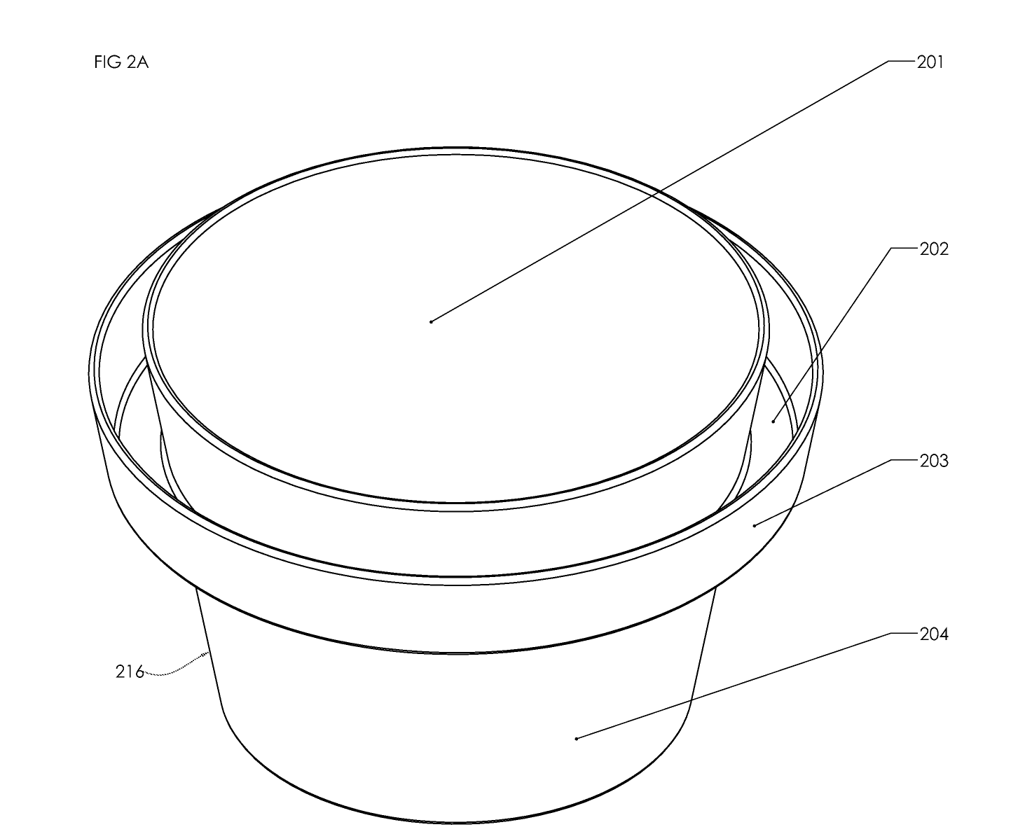

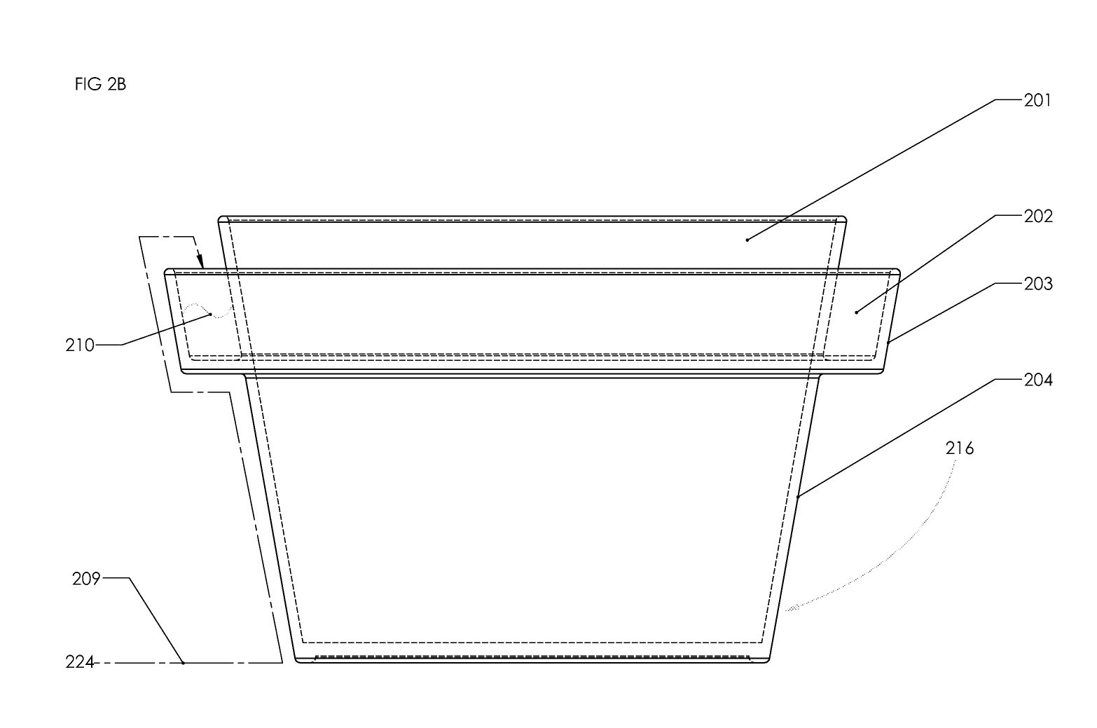

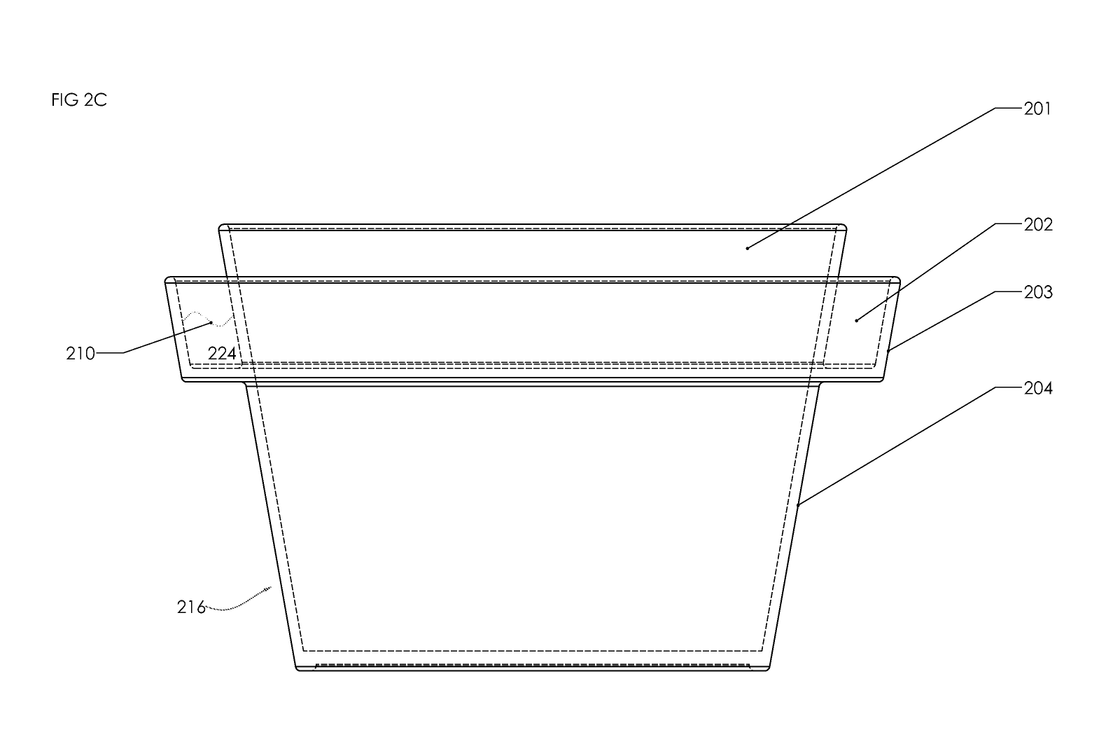

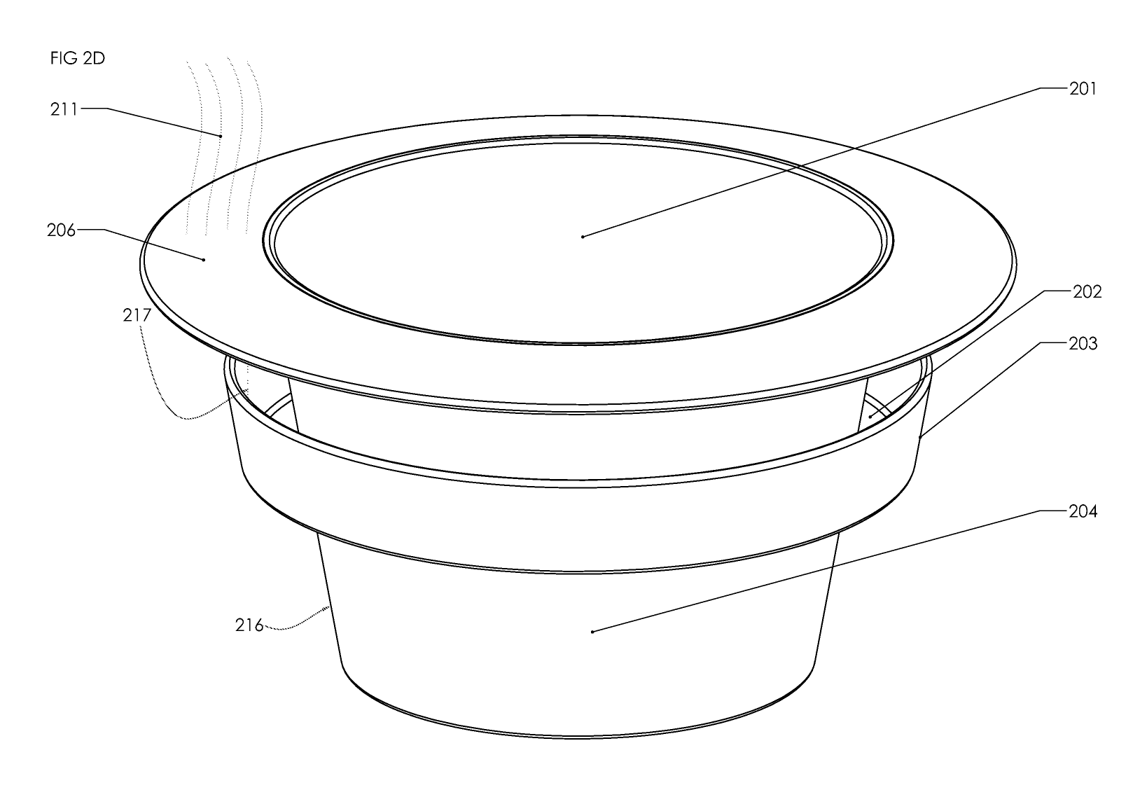

Referring to FIGS. 1A-1E and FIGS. 2A-2D, in some embodiments a pot 116, 216 includes a plant container 101, 201 for housing a plant and a trap container 102, 202 for housing a pest-controlling substance 110, 210 that either deters pests 124, 224 (e.g., pepper, eggshells) or attracts and traps pests 124, 224 (e.g., beer, salt), thereby preventing pests 124, 224 from entering the plant container 101, 201. The trap container 102, 202 can be coupled to the plant container 101, 201 along the perimeter of the plant container 101, 201. In order to prevent contents of the trap container 102, 202 from mixing with the contents of the plant container 101, 201, the trap container 102, 202 can be coupled to the plant container 101, 201 in such a way as to isolate the space inside the plant container 101, 201 from the space inside the trap container 102, 202, e.g., via wall or another physical barrier between the trap container 102, 202 and the plant container 101, 201.

In some embodiments, in order to limit entry of substances other than the pest-controlling substance into the trap container 102, 202, the pot 115, 215 further includes a roof element 106, 206. The roof element 106, 206 may be coupled to the plant container 101, 201 along the lateral perimeter of the first open-top container and positioned above the trap container 102, 202. Generally, the roof element 106, 206 may be positioned in a way so that the vertical gap 117, 217 between the top of the trap container 102, 202 and the roof element 106, 206 is large enough to allow the entry of pests 124, 224, but small enough to prevent access to the trap container 102, 202 by children, domesticated animals such as dogs and cats, and wild animals such as raccoons. As illustrated in FIGS. 1A-1E, in some embodiments, the roof element 106 may extend inward and upward from the enclosed wall portion 104 of the plant container 101. Alternatively, or additionally, as illustrated in FIGS. 2A-2D, in some embodiments, the roof element 206 element may extend outward and downward from the enclosed wall portion 204 of the plant container 201.

Generally, the trap container 102, 202 can be coupled to the trap container 101, 201 along various vertical positions on the plant container 101. For example, as illustrated in FIGS. 1A-1E, the trap container 102 can be coupled at the bottom of the plant container 101. In other embodiments, the trap container 202 may be coupled to the plant container 201 closer to the top of the plant container 201, as illustrated in FIGS. 2A-2D, for instance. The vertical position on the plant container 101, 201 where the trap container 102, 202 is coupled may depend on a variety of design considerations, as will be described below.

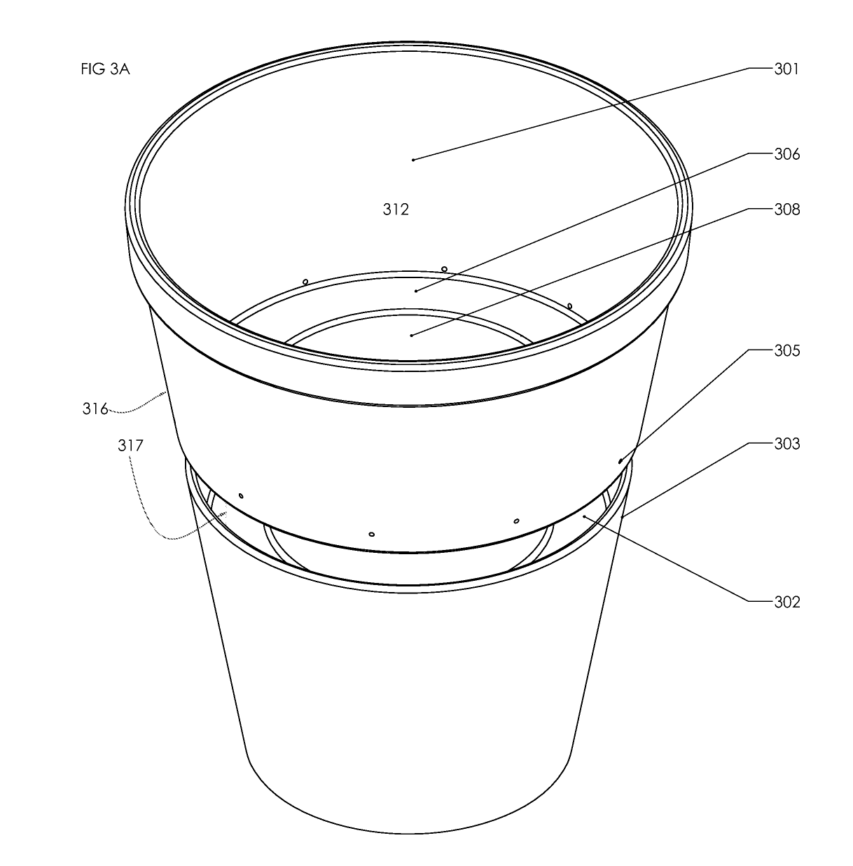

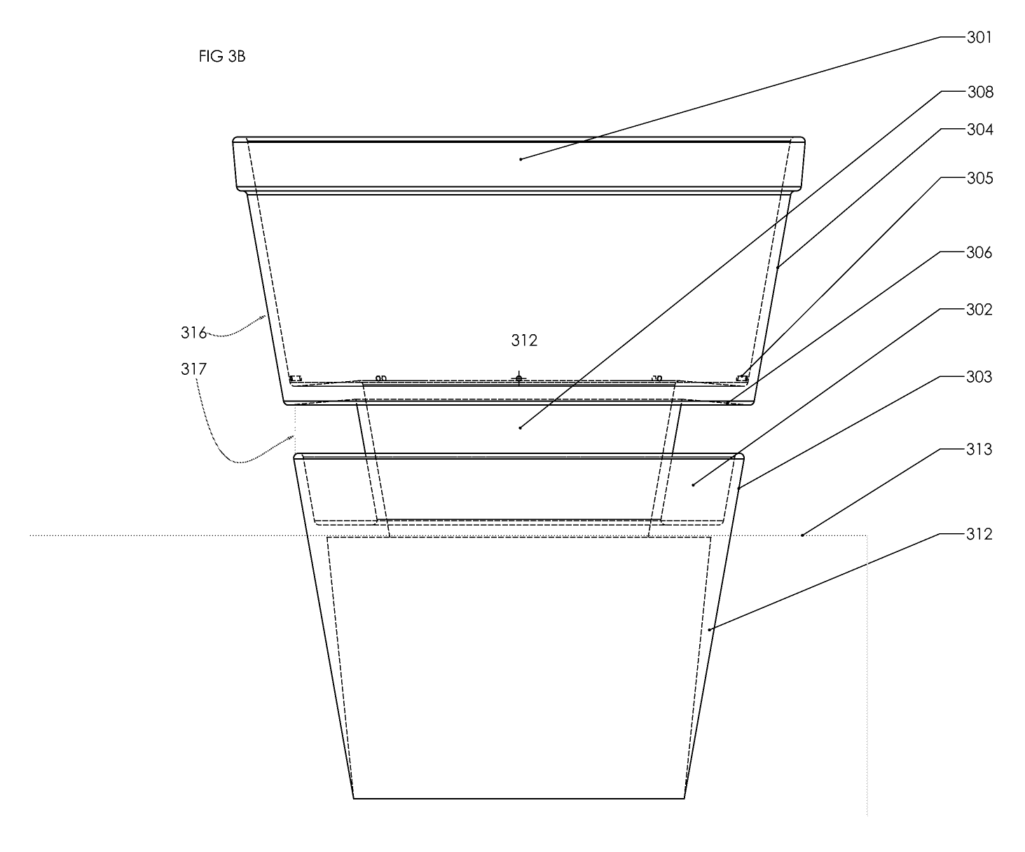

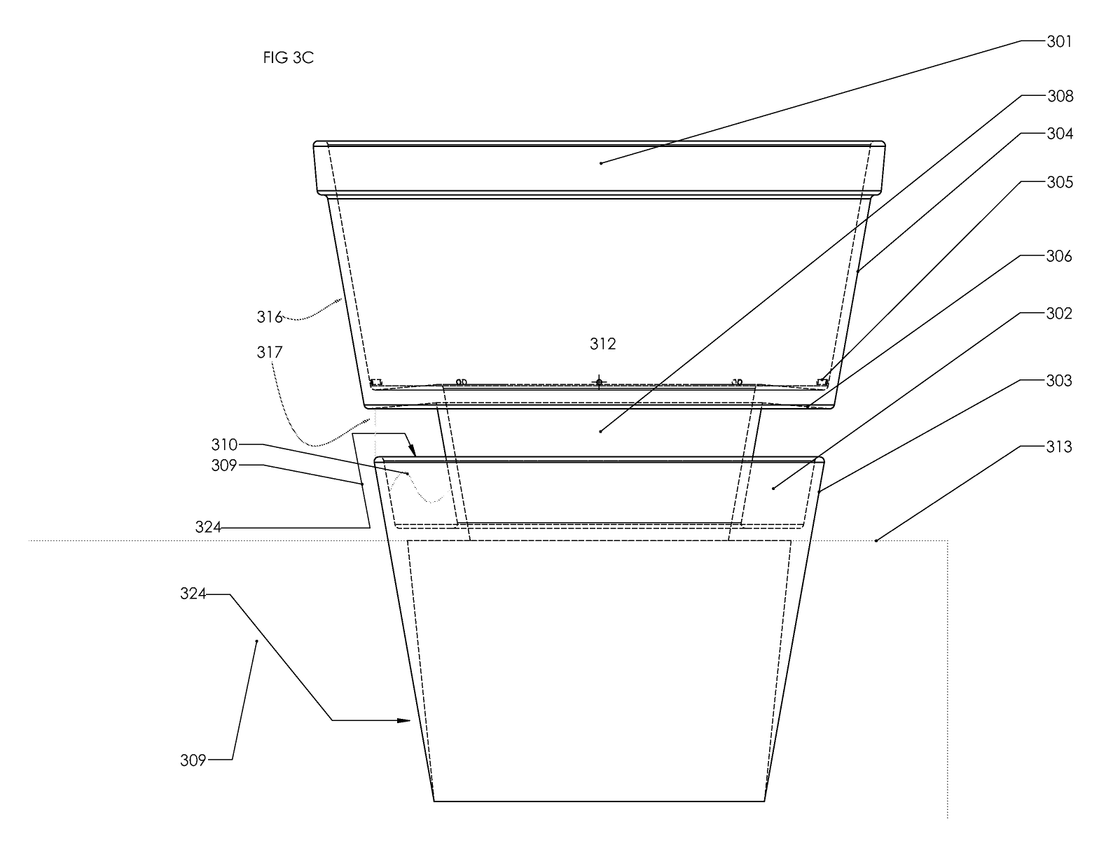

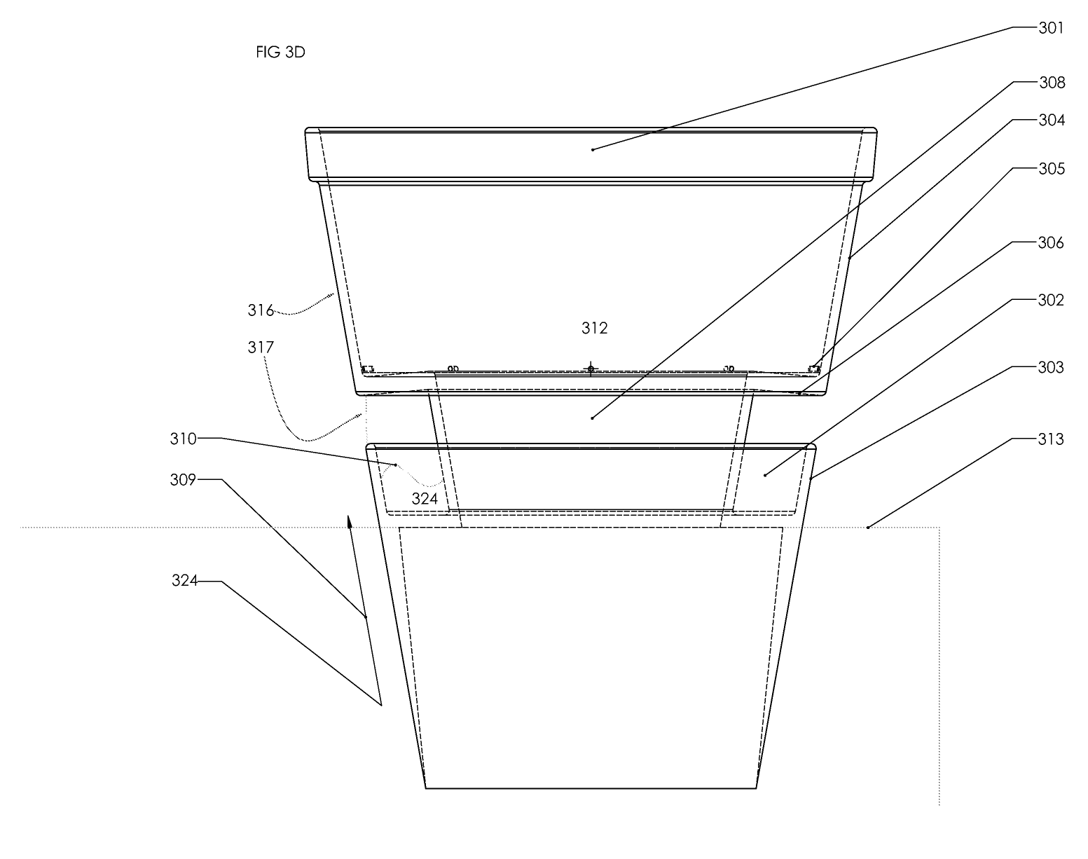

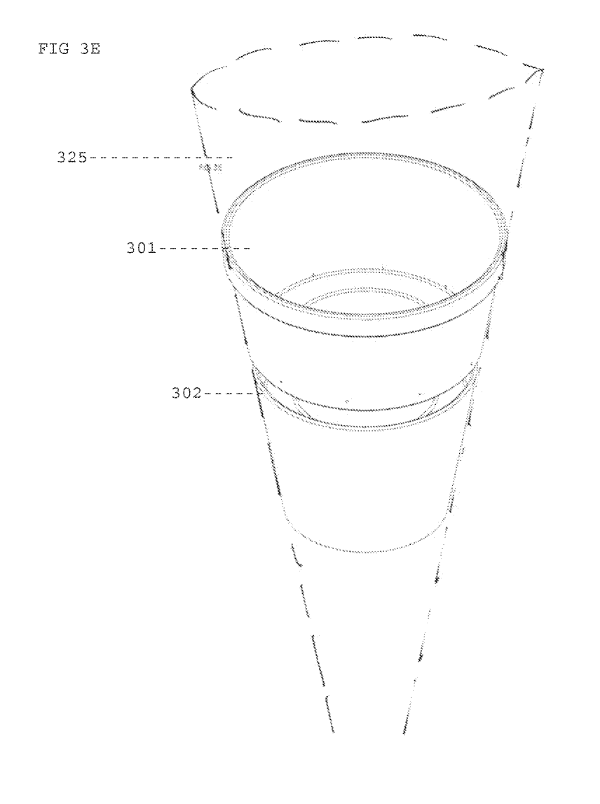

Referring to FIGS. 3A-3D, in some embodiments a pot 316 includes a hollow body 312 for housing a plant and trap container 312 for housing a pest-controlling substance 310, such as the pest-controlling substance 110, 210 described in reference to FIGS. 1A-1E and FIGS. 2A-2D. The trap container 302 can be coupled to the hollow body 312 along the perimeter of the hollow body 312. In order to prevent contents of the trap container 302 from mixing with the contents of the hollow body 312, the trap container 302 can be coupled to the hollow body 312 in such a way as to isolate the space inside the hollow body 312 from the space inside the trap container 312, e.g., via wall or another physical barrier 308 between the trap container 302 and the hollow body 312.

In some embodiments, in order to limit entry of substances other than the pest-controlling substance into the trap container 312, the pot 316 further includes a roof element 316 that may be similar to the roof elements 106, 206 discussed in reference to FIGS. 1A-1E and FIGS. 2A-2D. The roof element 316 may be coupled to the hollow body 312 along the lateral perimeter of the hollow body 312 and positioned above the trap container 302. In some embodiments, the roof element 316 is positioned in a way so that the vertical gap 317 between the top of the trap container 302 and the roof element 306 is large enough to allow the entry of pests 324, but small enough to prevent access to the trap by children, domesticated animals such as dogs and cats, and wild animals such as raccoons. As illustrated in FIGS. 3A-3E, in some embodiments, the roof element 306 may extend inward and upward from the enclosed wall portion 304 of the hollow body 312. Alternatively, or additionally, in some embodiments, the roof element 306 may extend outward and downward from the enclosed wall portion 304 of the hollow body 312 (not illustrated in FIGS. 3A-3D).

In some respect, the embodiments illustrated in FIGS. 3A-3D are similar to the embodiments described in reference to FIGS. 1A-1E. However, the embodiments illustrated in FIGS. 3A-3D include additional features and advantages. For instance, the a hollow body 312 illustrated in FIGS. 3A-3D can be deployed partially beneath ground level 313, allowing the roots of the plant in the hollow body 312 to continue growing deeper into the ground (past the confines of the above-ground portion of the hollow body 312) while still enjoying the protective utility of the trap container 302.

Referring to FIGS. 4A-4D, in some embodiments, a tray 420 for a plant pot 415 includes an open-top pot container 401 forming a first open space for housing a pot 415, and a trap container 402 for housing a pest-controlling substance 410 that either deters pests 424 (e.g., pepper, eggshells) or attracts and traps pests 424 (e.g., beer, salt), thereby preventing pests 424 from entering the plant pot 415 in the open-top pot container 401. The trap container 402 can be coupled to the open-top pot container 401 along the perimeter of the open-top pot container 401. In order to prevent contents of the trap container 402 from mixing with the contents of the open-top pot container 401, the trap container 402 can be coupled to the open-top pot container 401 in such a way as to isolate the space inside the open-top pot container 401 from the space inside the trap container 402 e.g., via wall or another physical barrier between the trap container 402 and the open-top pot container 401.

The basic operation of the tray 420 is to provide a wide, open-top container into which a user can place any suitable pot 415. In some embodiments, the tray 420 includes a floor section 405 for holding the pot 415. The floor section 405, on which the pot 415 rests, has at least on raised surface 414 that is in contact with the pot 415 when the pot 415 is housed in the first open-top container 401, and the raised surface 414 covers only a portion of the floor section 405. That way, contents that drain out of the pot 415 into the open-top pot container 401 are collected in one or more areas of the floor section 405 not covered by the raised surface 414.

One of the advantages of the embodiments illustrated in FIGS. 4A-4D is that they allow the user to retain his or her own pot 415, while still reaping the protective utility of the trap container 402. An additional distinction to these embodiments is the drainage system, which is effectively an overflow system, which allows the excess substances draining out of the pot 415 to overflow onto the roof 416 and drain onto the surface below, by dropping past but not into the trap container 402. These embodiments may be used in any area and on any surface on which gardening pots and plant containers are generally used.

The different embodiments of gardening disclosures illustrated in FIGS. 1A-1E will now be described in more detail.

Referring to FIGS. 1A-1E, in some embodiments, a pot 116 includes a plant container 101 to house a plant and soil (and, optionally, additional substances, such as fertilizer), and a trap container 102 to house some pest-controlling substance 110 that deters or attracts and traps pests 124. Generally, the plant container 101 includes an open top and an enclosed wall portion 104 that forms an open space (within the perimeter of the enclosed wall portion) for housing the plant. The trap container 102 may be coupled to the plant container 101 along the perimeter of the enclosed wall portion 104 of the plant container 101.

In order to prevent contents of the trap container 102 from mixing with the contents of the plant container 101, the trap container 102 can be coupled to the plant container 101 in such a way as to isolate the space inside the plant container 101 from the space inside the trap container 102, e.g., via wall or another physical barrier between the trap container 102 and the plant container 101.

In some embodiments, the pot 116 may include a roof element 106. As illustrated in FIGS. 1A-1E, the roof element 106 may extend inward and upward from the enclosed wall portion 104 of the plant container 101, and in some instances, the roof element 106 may extend past the trap container 102 in order to shield the trap container 102 from the elements and the effect of the elements, such as the dilution of pest-controlling substance 110 by rain or the evaporation of pest-controlling substance 110 by sunlight. The roof element 106 may also serves to limit the entry of those substances which the user does not intend to place in the trap container 102, by providing a limited point of entry, generally large enough to allow a pest or pests 124 while not allowing a larger animal such as a dog, cat, raccoon, etc.

In some embodiments, the pot 116 may include a drainage system that has at least one opening 105 in the enclosed wall portion 104 of the plant container 101 to allow at least some contents of the plant container 101 to drain out of the first plant container 101 via the opening 105 (or multiple openings 105). The drainage system may be positioned above the roof element 106 to limit entry into the trap container 102 of contents draining out of the plant container 101. The drainage system could allow substances of excess concentration to drain out of the plant container 101 to the benefit of the plant in the plant container 101. So, for example, if the user over-waters the plant in the plant container 101, or rain causes the plant container 101 to become over-saturated with water, the drainage system could allow the excess water to exit the plant container 101 to allow an appropriate degree of moisture in the plant container 101.

In some embodiments, the trap container 102 may be coupled to the lower portion of the plant container 101, with the roof element 106 extending inward and slightly upward from the enclosed wall portion 104 of the plant container 101. This upward tilt may provide for faster and more effective drainage in situations similar to those described by the preceding paragraph.

Generally, a variety of shapes can be used for the plant container 101 and the trap container 102, e.g. frusta of cone or pyramids. In the event where the plant container 101 and/or the trap container 102 take the shape of a frustum of a pyramid (or frusta of different pyramids), the plant container 101 and/or the trap container 102 may have any number of edges or faces, and the different edges and faces can have different lengths and/or areas, respectively. For example, the plant container 101 and/or the trap container 102 can be a square, a rectangular, hexagonal frustum, or a frustum with a variety of other bases. As illustrated in FIG. 1E, in some embodiments, in order for multiple pots like the pot 116 illustrated in FIGS. 1A-1E to be stackable, at least a portion of the plant container 101 and at least a portion of the trap container 102 outline a frustum of the same cone or pyramid 125. Although a frustum is one way to ensure stackability, a frustum is not necessary for the pot to be stackable. For example, so long as the perimeter of the trap component 102 is smaller than the perimeter of the plant container 101, and the perimeter of any given point on the pot 116 is smaller than the point immediately above it, the pot 116 will remain stackable with a similarly made pot 116.

In some embodiments, the trap container 102 is of such a depth that the pest-controlling substance 110 may safely be deployed within the trap container 102 without fear of being reached by children, domesticated animals, or similar sources of potential disruption of the trap contents, such as raccoons, wind, etc.

Because the partition 108 between the trap container 102 and the plant container 101 and the side portion 103 of the trap container 102 will, in many embodiments, have length sufficient to partially enclose some area of space between them, the trap container may be deep enough to allow the contents to act to deter or attract and trap pests 124, while still possibly being deep enough so that children or larger creatures such as domesticated animals would not be able to reach the contents, while most pests 124 such as snails, slugs, ants, and other pests 124, would be of such a small size that they would be able to crawl into where the pest-controlling substance 110 rests and thereby either be deterred by it or be attracted and trapped by it.

In some embodiments, the range of depth for the trap container can be from one half of one inch to two feet. In some embodiments, the range of distance between the exterior wall of the trap container 102 and the enclosed wall portion of the plant container 101 can be between half of one centimeter to eight centimeters. In some embodiments, the range of the vertical gap 117 between the roof element 106 and the exterior wall of the trap container 102 can be from one centimeter to sixteen centimeters.

In the various embodiments of the roof element 106, the roof can be a variety of sizes and lengths, of a variety of thickness, and could extend inward at a variety of angles from the enclosed wall portion of the plant container 101. One of ordinary skill in the art would understand that the roof element 106 could be made in a variety of ways, including a flat or substantially flat roof element 106 extending parallel with the surface below, a downward slanted roof element 106 extending from a higher point where the roof element 106 meets the enclosed wall portion 104 of the plant container 101 to a lower point where the roof element 106 meets the partition 108 between the trap container 102 and the plant container 101, or an upward slanted roof element 106 extending from a lower point where the roof meets the enclosed wall portion 104 of the plant container 101 to a higher point where the roof meets the partition 108 between the trap container 102 and the plant container 101.

In various embodiments, the roof element 106 could also include ridges, dots, raised surfaces, some sort of crevices, and otherwise not necessarily be a level surface. One of ordinary skill in the art would understand that the roof could be made in a variety of ways.

For the purposes of illustration, one particular type of roof element 106 is discussed, namely a roof element 106 with a consistent, straight surface slanted downward and extending inward from a lower point where the roof element 106 meets the enclosed wall portion 104 of the plant container 101 to a higher point where the roof element 106 meets the partition 108 between the trap container 102 and the plant container 101.

As illustrated in FIGS. 1A-1E, the pot 116 may be the frustum of a cone. This allows the pots 16 to be stacked when empty, allowing for more efficient storage and transportation. Furthermore, when the trap container 102 is part of a frustum of a cone or pyramid 125, the trap container 102 can be relatively concealed, allowing for more pleasing aesthetics in the trap container 102 design and creation.

The pest-controlling substance 110 can generally be any substance used to deter or attract and trap pests. Additionally, one or a combination of these substances may be household items. For example, assuming that the user is growing a dwarf lemon tree in the pot 116, one concern for the user would be a pest 124 known as scales.

Scales are parasitic, insect-like creatures that sink their appendages into citrus, and other, trees, damaging them. The scales are brought to the citrus trees by ant colonies; they protect the scales and help them grown in order to harvest the sugar-like secretions that the scales expel. In such a situation the user would be concerned about ants reaching his or her lemon tree. In using one of the embodiments of this pot 116, the user might plant the tree with the appropriate amount of soil in the plant container 101 and then fill the trap container 102 with ground pepper, or some other substance known to deter ants.

When ants 124 would try to reach the plant in the plant container 101, there would be no point of entry in the pot 116 to the plant container 101 that is vertically lower than the trap container 102. Therefore, to reach the plant in the plant container 101 the ants 124 would have to climb the side of the trap container 103 and climb into the trap container 102, before climbing up a partition 108 separating the plant container 101 and the trap container 102, before proceeding to climb the rest of the plant container 101 to reach the plant. This path is depicted by reference number “109” in FIG. 1B. Once the pest 124 come into contact with the substance 110 in the trap container 102 the pest would be deterred and turn back, without being able to cross to the previously mentioned partition 108 and without being able to reach the plant container 101.

For another example, let it be assumed the user is trying to grow strawberries in the pot 116. Some concerns for strawberries are slugs and snails 24, which damage the berries. Upon planting the strawberries and necessary soil in the plant container 101, the user may fill the trap container 102 with beer, salt, or some other pest-controlling substance 110 known to deter or attract and trap snails or slugs.

In this case, let it be assumed the user elects to deploy beer as the substance 110. When the pest 124 attempts to reach the plant container 101, it must first necessarily go through the trap container 102 as there are no points of entry into the plant container 101 below the trap. Furthermore, in some embodiments the vertical gap 117 between the roof element 106 and the side 103 of the trap container 102 may be of such a size so that a pest could not extend itself to such a length as to reach the roof without climbing the partition 108 between the plant container 101 and the trap container 102.

By entering the trap container 102 and coming into contact with the beer 110 the pest 124 may sustain a process analogous to inebriation, under which it may remain in the trap container 102 and never come out until the time of its expiration/death.

On the other hand, if environmental or other concerns lead the user to elect to use eggshells as the pest-controlling substance 110, the result would be the same except for pest 124 would be deterred or killed by the damaging effects eggshells have upon snails and slugs.

For another example, let it be assumed that the user would like to grow some sort of ornamental plant, such as fruitless figs, in the pot 116. Some ornamental plants are at risk of being eaten or damages by woodlice 124. After planting the plant in the plant container 101 with the appropriate soil, the user may fill the trap container 102 with diatomaceous earth.

When the pest 124 attempts to reach the plant container 101, it must first necessarily go through the trap container 102 as there are no points of entry into the plant container 101 below the trap container 102. Furthermore, in some embodiments the vertical gap between the roof element 106 and the side 103 of the trap container 102 may be of such a size so that a pest could not extend itself to such a length as to reach the roof element 106 without climbing the partition 108 between the plant container 101 and the trap container 102. This path is depicted by the reference number 109 in FIG. 1B.

By entering the trap container 102 and coming into contact with the diatomaceous earth 110, the pest 124 must crawl through or over the diatomaceous earth 110, and this will have the result of wearing out its shell. Even if the pest 124 lives long enough to exit the trap container 102 and enter the plant container 101, the pest 124 will likely die of dehydration shortly thereafter.

The use of household items in the trap container 102 as the pest-controlling substance 110 allows for a reduction in damage to the surrounding environment by harmful substances that might otherwise be used as pesticides to protect the plant. This leads to safer conditions for children and domesticated animals by removing the risk of accidental poisoning. The overall use of this pot 116 further reduces the global need for pesticide which reduces the globally harmful byproducts of pesticide production.

The pot 116 can be made from various materials. It can be made from plastic, clay, or any other suitable material. One of ordinary skill in the art will understand that various other materials can be used to produce this pot. The various materials can be used to meet a variety of weight, climate, aesthetic, or other considerations, and a change in the device's material components does not affect the utility or use of some of the embodiments.

The pot 116 can be made in a variety of sizes. One of ordinary skill in the art will understand that a variety of sizes are possible without compromising the utility of the pot 116.

The embodiments illustrated in FIGS. 1A-1E may be deployed on any terrain where gardening pots are commonly used, including sidewalks, earth, sand, balconies, wooden decks, etc. One of ordinary skill in the art will understand that a variety of terrains or surfaces are suitable for the embodiments illustrated in FIGS. 1A-1E. The embodiments illustrated in FIGS. 1A-1E may be deployed indoors, outdoors, and to a variety of “in-between” areas such as gazebos, partial enclosures, balconies, canopied decks, etc. One of ordinary skill in the art will understand that there are a variety of places where these embodiments may be deployed.

The different embodiments of gardening disclosures illustrated in FIGS. 2A-2D will now be described in more detail.

Referring to FIGS. 2A-2D, in some embodiments, a pot 216 includes a plant container 201 to house a plant and soil (and, optionally, additional substances, such as fertilizer), and a trap container 202 to house some pest-controlling substance 210 that deters or attracts and traps pests 224. Generally, the plant container 201 includes an open top and an enclosed wall portion 204 that forms an open space (within the perimeter of the enclosed wall portion) for housing the plant. The trap container 202 may be coupled to the plant container 201 along the perimeter of the enclosed wall portion 204 of the plant container 201.

In order to prevent contents of the trap container 202 from mixing with the contents of the plant container 201, the trap container 202 can be coupled to the plant container 201 in such a way as to isolate the space inside the plant container 201 from the space inside the trap container 202, e.g., via wall or another physical barrier between the trap container 202 and the plant container 201.

In some embodiments, the pot 216 may include a roof element 206. As illustrated in FIGS. 2A-2D, in some embodiments, the roof element 206 may extend outward and downward from the enclosed wall portion 204 of the plant container 201. The full length of the roof element 206 may be of such degree so as to extend past the trap container 202 to allow the roof element 206 to shield the trap from the elements and the effect of the elements, such as the dilution of pest-controlling substance 210 by rain or the evaporation of pest-controlling substance 210 by sunlight. The roof element 206 may also serves to limit the entry of those substances which the user does not intend to place in the trap container 202, by providing a limited point of entry, generally large enough to allow a pest or pests 224 while not allowing a larger animal such as a dog, cat, raccoon, etc. Depending on the circumstances in which the pot 216 would be deployed, a roof element 206 element may not be necessary. Therefore, some of the embodiments, as illustrated in FIGS. 2A-2C do not have a roof element 206 element, while the embodiment illustrated in FIG. 2D does. A roof element may not be necessary if the pot 216 is to be deployed indoors, or perhaps in a covered area such as a canopied deck, a gazebo, or large balcony, where the danger of the elements 206 is not a concern.

The trap container 202 may be coupled to the upper portion of the plant container 201, with a roof element 206 extending outward and slightly downward from the enclosed wall portion of the plant container 201. This downward tilt may provide for faster and more effective disposal of overflow in situations, such as rain or the over-watering of the plant container, where the excess water from the plant container 201 flows over the roof element 206 and past, but not into, the trap container 202.

Generally, a variety of shapes can be used for the plant container 201 and the trap container 202, e.g. frusta of cone or pyramids 225. In the event where the plant container 201 and/or the trap container 202 take the shape of a frustum of a pyramid (or frusta of different pyramids), the plant container 201 and/or the trap container 202 may have any number of edges or faces, and the different edges and faces can have different lengths and/or areas, respectively. For example, the plant container 201 and/or the trap container 202 can be a square, a rectangular, hexagonal frustum, or a frustum with a variety of other bases. As illustrated in FIG. 2D, in some embodiments, in order for multiple pots like the pot 216 illustrated in FIGS. 2A-2D to be stackable, at least a portion of the plant container 201 and at least a portion of the trap container 202 outline a frustum of the same cone or pyramid 225. Although a frustum is one way to ensure stackability, a frustum is not necessary for the pot to be stackable. For example, so long as the perimeter of the trap component 202 is larger than the perimeter of the plant container 201, and the perimeter of any given point on the pot 216 is smaller than the point immediately above it, the pot 216 will remain stackable with a similarly made pot 216.

Because the enclosed wall portion 204 of the plant container 201 and the side portion 203 of the trap container 202 will, in many embodiments, have length sufficient to partially enclose some area of space between them, the trap container may be deep enough to allow the contents to act to deter or attract and trap pests 224, while still possibly being deep enough so that children or larger creatures such as domesticated animals would not be able to reach the contents, while most pests 224 such as snails, slugs, ants, and other pests 224, would be of such a small size that they would be able to crawl into where the pest-controlling substance 210 rests and thereby either be deterred by it or be attracted and trapped by it.

The range of depth for the trap container can be from one half of one inch to two feet. The range of distance between the exterior wall of the trap container 202 and the enclosed wall portion of the plant container 201 can be between half of one centimeter to eight centimeters. The range of the vertical gap 217 between the roof element 206 and the exterior wall of the trap container 202 can be from one centimeter to sixteen centimeters.

In the various embodiments of the roof element 206, the roof can be a variety of sizes and lengths, of a variety of thickness, and could extend inward at a variety of angles from the enclosed wall portion of the plant container 201. One of ordinary skill in the art would understand that the roof element 206 could be made in a variety of ways, including a flat or substantially flat roof element 206 extending parallel with the surface below, a “downward slanted” roof element 206 extending from a higher point where the roof element 206 meets the enclosed wall portion 204 of the plant container 201 to a lower point where the roof element 206 meets the partition 208 between the trap container 202 and the plant container 201, or an “upward slanted” roof element 206 extending from a lower point where the roof meets the enclosed wall portion 204 of the plant container 201 to a higher point where the roof meets the partition 208 between the trap container 202 and the plant container 201.

In various embodiments, the roof element 206 could also include ridges, dots, raised surfaces, some sort of crevices, and otherwise not necessarily be a level surface. One of ordinary skill in the art would understand that the roof could be made in a variety of ways.

For the purposes of illustration, one particular type of roof element 206 is discussed, namely a roof element 206 with a consistent, straight surface slanted downward and extending inward from a lower point where the roof element 206 meets the enclosed wall portion 204 of the plant container 201 to a higher point where the roof element 206 meets the partition 208 between the trap container 202 and the plant container 201.

As illustrated in FIGS. 2A-2D, the pot 216 may be the frustum of a cone. This allows the pots 16 to be stacked when empty, allowing for more efficient storage and transportation. Furthermore, when the trap container 202 is part of a frustum of a cone or pyramid 225, the trap container 202 can be relatively concealed, allowing for more pleasing aesthetics in the trap container 202 design and creation.

The pest-controlling substance 210 can generally be any substance used to deter or attract and trap pests. Additionally, one or a combination of these substances may be household items. For example, assuming that the user is growing a dwarf lemon tree in the pot 216, one concern for the user would be a pest 224 known as scales.

Scales are parasitic, insect-like creatures that sink their appendages into citrus, and other, trees, damaging them. The scales are brought to the citrus trees by ant colonies; they protect the scales and help them grown in order to harvest the sugar-like secretions that the scales expel. In such a situation the user would be concerned about ants reaching his or her lemon tree. In using one of the embodiments of this pot 216, the user might plant the tree with the appropriate amount of soil in the plant container 201 and then fill the trap container 202 with ground pepper, or some other substance known to deter ants.

When ants 224 would try to reach the plant in the plant container 201, there would be no point of entry in the pot 216 to the plant container 201 that is vertically lower than the trap container 202. Therefore, to reach the plant in the plant container 201 the ants 224 would have to climb the side of the trap container 3 and climb into the trap container 202, before climbing up the enclosed wall portion 204 separating the plant container 201 and the trap container 202, before reaching the plant container 201 to reach the plant. This path is depicted by the reference number “209” in FIG. 2B Once the pest 224 come into contact with the pest-controlling substance 210 in the trap container 202 the pest would be deterred and turn back, without being able to climb over the enclosed wall portion 204 and without being able to reach the plant container 201.

For another example, let it be assumed the user is trying to grow strawberries in the pot 216. Some concerns for strawberries are slugs and snails 224, which damage the berries. Upon planting the strawberries and necessary soil in the plant container 201, the user may fill the trap container 202 with beer, salt, or some other pest-controlling substance 210 known to deter or attract and trap snails or slugs.

In this case, let it be assumed the user elects to deploy beer as the pest-controlling substance 210. When the pest 224 attempts to reach the plant container 201, it must first necessarily go through the trap container 202 as there are no points of entry into the plant container 201 below the trap. Furthermore, in some embodiments the vertical gap 217 between the roof element 206 and the side 203 of the trap container 202 may be of such a size so that a pest could not extend itself to such a length as to reach the roof without climbing the partition 208 between the plant container 201 and the trap container 202.

By entering the trap container 202 and coming into contact with the beer 210 the pest 224 may sustain a process analogous to inebriation, under which it may remain in the trap container 202 and never come out until the time of its expiration/death.

On the other hand, if environmental or other concerns lead the user to elect to use eggshells as the substances 210, the result would be the same except for pest 224 would be deterred or killed by the damaging effects eggshells have upon snails and slugs.

For another example, let it be assumed that the user would like to grow some sort of ornamental plant, such as fruitless figs, in the pot 216. Some ornamental plants are at risk of being eaten or damages by woodlice 224. After planting the plant in the plant container 201 with the appropriate soil, the user may fill the trap container 202 with diatomaceous earth.

When the pest 224 attempts to reach the plant container 201, it must first necessarily go through the trap container 202 as there are no points of entry into the plant container 201 below the trap container 202. Furthermore, in some embodiments the vertical gap between the roof element 206 and the side 203 of the trap container 202 may be of such a size so that a pest could not extend itself to such a length as to reach the roof element 206 without climbing the partition 208 between the plant container 201 and the trap container 202. This path is depicted by the reference number “209” in FIG. 2B.

By entering the trap container 202 and coming into contact with the diatomaceous earth 210, the pest 224 must crawl through or over the diatomaceous earth 210, and this will have the result of wearing out its shell. Even if the pest 224 lives long enough to exit the trap container 202 and enter the plant container 201, the pest 224 will likely die of dehydration shortly thereafter.

The use of household items in the trap container 202 as the pest-controlling substance 210 allows for a reduction in damage to the surrounding environment by harmful substances that might otherwise be used as pesticides to protect the plant. This leads to safer conditions for children and domesticated animals by removing the risk of accidental poisoning. The overall use of this pot 216 further reduces the global need for pesticide which reduces the globally harmful byproducts of pesticide production.

The pot 216 can be made from various materials. It can be made from plastic, clay, or any other suitable material. One of ordinary skill in the art will understand that various other materials can be used to produce this pot. The various materials can be used to meet a variety of weight, climate, aesthetic, or other considerations, and a change in the device's material components does not affect the utility or use of some of the embodiments.

The pot 216 can be made in a variety of sizes. One of ordinary skill in the art will understand that a variety of sizes are possible without compromising the utility of the pot 216.

The embodiments illustrated in FIGS. 2A-2D may be deployed on any terrain where gardening pots are commonly used, including sidewalks, earth, sand, balconies, wooden decks, etc. One of ordinary skill in the art will understand that a variety of terrains or surfaces are suitable for the embodiments illustrated in FIGS. 2A-2D. The embodiments illustrated in FIGS. 2A-2D may be deployed indoors, outdoors, and to a variety of “in-between” areas such as gazebos, partial enclosures, balconies, canopied decks, etc. One of ordinary skill in the art will understand that there are a variety of places where these embodiments may be deployed.

The different embodiments of gardening disclosures illustrated in FIGS. 3A-3E will now be described in more detail.

Referring to FIGS. 3A-3E, in some embodiments, a pot 316 made up of a hollow body 312 forming a first open space for housing a plant, the hollow body being made up of an enclosed wall portion 304 that forms a lateral perimeter of the hollow body, meant to house a plant and soil (and, optionally, additional substances, such as fertilizer), as well as a trap container 302 to house some pest-controlling substance 310 that deters or attracts and traps pests 324. In order to prevent contents of the trap container 302 from mixing with the contents of the hollow body 312, the trap container 302 can be coupled to the hollow body 312 in such a way as to isolate the space inside the hollow body 312 from the space inside the trap container 302, e.g., via wall or another physical barrier between the hollow body 312 and the hollow body 312. In some embodiments, the hollow body 312 may at points narrow or close completely.

In some embodiments, the pot 316 is deployed in such a manner that the bottom of the trap container 302 sits at ground level 313, coupled to the lower portion of the hollow body, and at least some portion of the hollow body 312 is generally deployed beneath ground level 313, allowing the roots of the plant placed within the hollow body 312 to continue growing past the confines of the pot 316.

In some embodiments, the pot 316 may include a roof element 306. As illustrated in FIGS. 3A-3E, in some embodiments, the roof element 306 may extend inward and upward from the enclosed wall portion 304 of the hollow body 312. The full length of the roof element 306 may be of such degree so as to extend past the trap container 302 to allow the roof element 306 to shield the trap from the elements and the effect of the elements, such as the dilution of pest-controlling substance 310 by rain or the evaporation of pest-controlling substance 310 by sunlight. The roof element 306 may also serves to limit the entry of those substances which the user does not intend to place in the trap container 302, by providing a limited point of entry, generally large enough to allow a pest or pests 324 while not allowing a larger animal such as a dog, cat, raccoon, etc.

The trap container 302 may be coupled to the lateral perimeter of the lower portion of the hollow body 312, but generally the trap container 302 may be deployed at ground level. In those embodiments in which the hollow body 312 does not at any point narrow to the point of creating an enclosure, drainage of excess substances such as water is performed by allowing the substances, such as water, to drain into the soil below the pot 316.

Generally, the hollow body 312 includes an open top and an enclosed wall portion 304 that forms an open space (within the perimeter of the enclosed wall portion) for housing the plant. The trap container 302 may be coupled to the hollow body 312 along the lateral perimeter of the enclosed wall portion 304 of the hollow body 312. Generally, a variety of shapes can be used for the hollow body 312 and the trap container 302, e.g. frusta of cone or pyramids 325. In the event where the hollow body 312 and/or the trap container 302 take the shape of a frustum of a pyramid (or frusta of different pyramids), the hollow body 312 and/or the trap container 302 may have any number of edges or faces, and the different edges and faces can have different lengths and/or areas, respectively. For example, the hollow body 312 and/or the trap container 302 can be a square, a rectangular, hexagonal frustum, or a frustum with a variety of other bases. As illustrated in FIG. 3E, in some embodiments, in order for multiple pots like the pot 316 illustrated in FIGS. 3A-3E to be stackable, at least a portion of the hollow body 312 and at least a portion of the trap container 302 outline a frustum of the same cone or pyramid 325. Although a frustum is one way to ensure stackability, a frustum is not necessary for the pot to be stackable. For example, so long as the perimeter of the trap component 302 is smaller than the perimeter of the plant container 301, and the perimeter of any given point on the pot 316 is smaller than the point immediately above it, the pot 316 will remain stackable with a similarly made pot 316.

In some embodiments, the trap container 302 is of such a depth that the pest-controlling substance 310 may safely be deployed without fear of being reached by children, domesticated animals, or similar sources of potential disruption of the trap contents, such as raccoons, wind, etc.

Because the partition 308 between the trap container 302 and the hollow body 312 and the side portion 303 of the trap container 302 will, in many embodiments, have length sufficient to partially enclose some area of space between them, the trap container may be deep enough to allow the contents to act to deter or attract and trap pests 324, while still possibly being deep enough so that children or larger creatures such as domesticated animals would not be able to reach the contents, while most pests 324 such as snails, slugs, ants, and other pests 324, would be of such a small size that they would be able to crawl into where the substance 310 rests and thereby either be deterred by it or be attracted and trapped by it.

The range of depth for the trap container can be from one half of one inch to two feet. The range of distance between the exterior wall of the trap container 302 and the enclosed wall portion of the hollow body 312 can be between half of one centimeter to eight centimeters. The range of the vertical gap 317 between the roof element 306 and the exterior wall of the trap container 302 can be from one centimeter to sixteen centimeters.

In the various embodiments of the roof element 306, the roof can be a variety of sizes and lengths, of a variety of thickness, and could extend inward at a variety of angles from the enclosed wall portion of the hollow body 312. One of ordinary skill in the art would understand that the roof element 306 could be made in a variety of ways, including a flat or substantially flat roof element 306 extending parallel with the surface below, a “downward slanted” roof element 306 extending from a higher point where the roof element 306 meets the enclosed wall portion 304 of the hollow body 312 to a lower point where the roof element 306 meets the partition 308 between the trap container 302 and the hollow body 312, or an “upward slanted” roof element 306 extending from a lower point where the roof meets the enclosed wall portion 304 of the hollow body 312 to a higher point where the roof meets the partition 308 between the trap container 302 and the hollow body 312.

In various embodiments, the roof element 306 could also include ridges, dots, raised surfaces, some sort of crevices, and otherwise not necessarily be a level surface. One of ordinary skill in the art would understand that the roof could be made in a variety of ways.

For the purposes of illustration, one particular type of roof element 306 is discussed, namely a roof element 306 with a consistent, straight surface slanted downward and extending inward from a lower point where the roof element 306 meets the enclosed wall portion 304 of the hollow body 312 to a higher point where the roof element 306 meets the partition 308 between the trap container 302 and the hollow body 312.

As illustrated in FIGS. 3A-3E, the pot 316 may be the frustum of a cone. This allows the pots 16 to be stacked when empty, allowing for more efficient storage and transportation. Furthermore, when the trap container 302 is part of a frustum of a cone or pyramid 325, the trap container 302 can be relatively concealed, allowing for more pleasing aesthetics in the trap container 302 design and creation.

The pest-controlling substance 310 can generally be any substance used to deter or attract and trap pests. Additionally, one or a combination of these substances may be household items. For example, assuming that the user is growing a dwarf lemon tree in the pot 316, one concern for the user would be a pest 324 known as scales.

Scales are parasitic, insect-like creatures that sink their appendages into citrus, and other, trees, damaging them. The scales are brought to the citrus trees by ant colonies; they protect the scales and help them grown in order to harvest the sugar-like secretions that the scales expel. In such a situation the user would be concerned about ants reaching his or her lemon tree. In using one of the embodiments of this pot 316, the user might plant the tree with the appropriate amount of soil in the hollow body 312 and then fill the trap container 302 with ground pepper, or some other substance known to deter ants.

When ants 324 would try to reach the plant in the hollow body 312, there would be no point of entry in the pot 316 to the hollow body 312 that is vertically lower than the trap container 302. Therefore, to reach the plant in the hollow body 312 the ants 324 would have to climb the side of the trap container 3 and climb into the trap container 302, before climbing up a partition 308 separating the hollow body 312 and the trap container 302, before proceeding to climb the rest of the hollow body 312 to reach the plant. This path is depicted by the reference number “309” in FIG. 1B. Once the pest 324 come into contact with the substance 310 in the trap container 302 the pest would be deterred and turn back, without being able to cross to the previously mentioned partition 308 and without being able to reach the hollow body 312.

For another example, let it be assumed the user is trying to grow strawberries in the pot 316. Some concerns for strawberries are slugs and snails 324, which damage the berries. Upon planting the strawberries and necessary soil in the hollow body 312, the user may fill the trap container 302 with beer, salt, or some other substance 310 known to deter or attract and trap snails or slugs.

In this case, let it be assumed the user elects to deploy beer as the substance 310. When the pest 324 attempts to reach the hollow body 312, it must first necessarily go through the trap container 302 as there are no points of entry into the hollow body 312 below the trap. Furthermore, in some embodiments the vertical gap 317 between the roof element 306 and the side portion 303 of the trap container 302 may be of such a size so that a pest could not extend itself to such a length as to reach the roof without climbing the partition 308 between the hollow body 312 and the trap container 302.

By entering the trap container 302 and coming into contact with the beer 310 the pest 324 may sustain a process analogous to inebriation, under which it may remain in the trap container 302 and never come out until the time of its expiration/death.

On the other hand, if environmental or other concerns lead the user to elect to use eggshells as the pest-controlling substance 310, the result would be the same except for pest 324 would be deterred or killed by the damaging effects eggshells have upon snails and slugs.

For another example, let it be assumed that the user would like to grow some sort of ornamental plant, such as fruitless figs, in the pot 316. Some ornamental plants are at risk of being eaten or damages by woodlice 324. After planting the plant in the hollow body 312 with the appropriate soil, the user may fill the trap container 302 with diatomaceous earth.

When the pest 324 attempts to reach the hollow body 312, it must first necessarily go through the trap container 302 as there are no points of entry into the hollow body 312 below the trap container 302. Furthermore, in some embodiments the vertical gap between the roof element 306 and the side portion 303 of the trap container 302 may be of such a size so that a pest could not extend itself to such a length as to reach the roof element 306 without climbing the partition 308 between the hollow body 312 and the trap container 302. This path is depicted by the reference number “309” in FIG. 1B.

By entering the trap container 302 and coming into contact with the diatomaceous earth 310, the pest 324 must crawl through or over the diatomaceous earth 310, and this will have the result of wearing out its shell. Even if the pest 324 lives long enough to exit the trap container 302 and enter the hollow body 312, the pest 324 will likely die of dehydration shortly thereafter.

The use of household items in the trap container 302 as the pest-controlling substance 310 allows for a reduction in damage to the surrounding environment by harmful substances that might otherwise be used as pesticides to protect the plant. This leads to safer conditions for children and domesticated animals by removing the risk of accidental poisoning. The overall use of this pot 316 further reduces the global need for pesticide which reduces the globally harmful byproducts of pesticide production.

The pot 316 can be made from various materials. It can be made from plastic, clay, or any other suitable material. One of ordinary skill in the art will understand that various other materials can be used to produce this pot. The various materials can be used to meet a variety of weight, climate, aesthetic, or other considerations, and a change in the device's material components does not affect the utility or use of some of the embodiments.

The pot 316 can be made in a variety of sizes. One of ordinary skill in the art will understand that a variety of sizes are possible without compromising the utility of the pot 316.

The embodiments illustrated in FIGS. 3A-3E may be deployed on any terrain where gardening pots are commonly used, including sidewalks, earth, sand, balconies, wooden decks, etc. One of ordinary skill in the art will understand that a variety of terrains or surfaces are suitable for the embodiments illustrated in FIGS. 3A-3E. The embodiments illustrated in FIGS. 3A-3E may be deployed indoors, outdoors, and to a variety of “in-between” areas such as gazebos, partial enclosures, balconies, canopied decks, etc. One of ordinary skill in the art will understand that there are a variety of places where these embodiments may be deployed.

Generally, a variety of shapes can be used for the pot 316, e.g. a frustum of a cone or a pyramid. In the event where the pot take the generally shape of the frustum of a pyramid, it can have any number of edges or faces. For example, it can have a square, a rectangular, hexagonal frustum.

In most embodiments, the trap container 302 is of such a depth that the pest-controlling substance 310 may safely be deployed without fear of being reached by children, domesticated animals, or similar sources of potential disruption of the trap contents, such as raccoons, wind, etc.

Because the side portion of the hollow body 312 and the side portion of the trap container 302 will, in many embodiments, be of at least some length, the trap container may be deep enough to allow the contents to act to deter or attract and trap pests 324, while still possibly being deep enough so that children or larger creatures such as domesticated animals would not be able to reach the contents, while most pests 324 such as snails, slugs, ants, and other pests 324, would be of such a small size that they would be able to crawl into where the substance 310 rests and thereby either be deterred by it or be attracted and trapped by it.

The pot 316 can be made from various materials. It can be made from plastic, clay, or any other suitable material. One of ordinary skill in the art will understand that various other materials can be used to produce this pot. The various materials can be used to meet a variety of weight, climate, aesthetic, or other considerations, and a change in the device's material components does not affect the utility or use of some of the embodiments.

The pot 316 can be made in a variety of sizes. One of ordinary skill in the art will understand that a variety of sizes are possible without compromising the utility of the pot 316. Thus, various sizes of the pot 316 can be used to meet a variety of space, aesthetic, plants-to-be-grown, or other considerations.

The embodiments illustrated in FIGS. 3A-3D may be deployed on soil, earth, sand, or any other substance that is generally acceptable for the purpose of growing roots. One of ordinary skill in the art will understand that a variety of terrains or surfaces are suitable for the embodiments illustrated in FIGS. 3A-3D. The embodiments illustrated in FIGS. 3A-3D may be deployed indoors, outdoors, and to a variety of “in-between” areas such as gazebos, partial enclosures, canopied decks, etc., so long as the roots of the plant planted in the hollow body 312 are given access to some sort of terrain in which they can grow. One of ordinary skill in the art will understand that there are a variety of places where these embodiments may be deployed.

In the various embodiments of the roof element 306, the roof can be a variety of sizes and lengths, of a variety of thickness, and could extend inward at a variety of angles from the outermost side portion of the hollow body 312. One of ordinary skill in the art would understand that the roof element 306 could be made in a variety of ways, including a flat or substantially flat roof element 306 extending parallel with the surface below, a “downward slanted” roof element 306 extending from a higher point where the roof element 306 meets the side portion of the hollow body 312 to a lower point where the roof element 306 meets the partition 308 between the trap container 302 and the hollow body 312, or an “upward slanted” roof element 306 extending from a lower point where the roof meets the outermost side portion of the hollow body 312 to a higher point where the roof meets the partition 308 between the trap container 302 and the hollow body 312.

In various embodiments, the roof element 306 could also include ridges, dots, raised surfaces, some sort of crevices, and otherwise not necessarily be a level surface. One of ordinary skill in the art would understand that the roof could be made in a variety of ways.

For the purposes of illustration, one particular type of roof element 306 is discussed, namely a roof with a consistent, straight surface slanted downward and extending inward from a lower point where the roof element 306 meets the side portion of the hollow body 312 to a higher point where the roof element 306 meets the partition 308 between the trap container 302 and the hollow body 312.

The trap container 302 may be coupled to the lower portion of the hollow body 312, with a roof element 306 extending inward and slightly upward from the outermost perimeter of the hollow body 312.

The full length of the roof element 306 may be of such degree so as to extend past the trap container 302 to allow the roof element 306 to shield the trap from the elements and the effect of the elements, such as the dilution of pest-controlling substance 310 by rain or the evaporation of pest-controlling substance 310 by sunlight. The roof element 306 also serves to limit the entry of those substances which the user does not intend to place in the trap container 302, by providing a limited point of entry, generally large enough to allow a pest 324 while not allowing a larger animal such as a dog, cat, raccoon, etc.

The full length of the roof element 306 may be of such degree so as to extend past the trap container 302 to allow the roof element 306 to shield the trap from the elements and the effect of the elements, such as the dilution of pest-controlling substance 310 by rain or the evaporation of pest-controlling substance 310 by sunlight. The roof element 306 also serves to limit the entry of those substances which the user does not intend to place in the trap container 302, by providing a limited point of entry, generally large enough to allow a pest 324 entry while barring entry for a larger animal such as a dog, cat, raccoon, etc.

Generally, the shape of the pot 316 may be that of a frustum, and as illustrated in FIGS. 3A-3D may be the frustum of a cone. This allows the pots 16 to be stacked when empty, allowing for more efficient storage and transportation.

The pest-controlling substance 310 can generally be any substance used to deter or attract and kill pests. Additionally, one or a combination of these substances may be household items. For example, assuming that the user is growing a dwarf lemon tree in the pot 316, one concern for the user would be a pest 324 known as scales.

Scales are parasitic, insect-like creatures that sink their appendages into citrus, and other, trees, damaging them. The scales are brought to the citrus trees by ant colonies; they protect the scales and help them grown in order to harvest the sugar-like secretions that the scales expel. In such a situation the user would be concerned about ants reaching his or her lemon tree. In using one of the embodiments of this pot 316, the user might plant the tree with the appropriate amount of soil in the hollow body 312 and then fill the trap container 302 with ground pepper, or some other substance known to deter ants.

When ants 324 would try to reach the plant in the hollow body 312, there would be no point of entry in the pot 316 to the hollow body 312 that is vertically lower than the trap container 302. Therefore, to reach the plant in the hollow body 312 the ants 324 would have to climb the side of the trap and climb into the trap container 302, before climbing up a partition 308 separating the hollow body 312 and the trap container 302, before proceeding to climb the rest of the hollow body 312 to reach the plant. This path is depicted by the reference number “309” in FIG. 3C. Once the pest 324 come into contact with the substance in the trap 310 the pest would be deterred and turn back, without being able to cross to the previously mentioned partition 308 and without being able to reach the hollow body 312.

The hollow body 312 would extend to such length below the ground level 313 that the pests 324 would be unlikely to burrow deep enough to go around the hollow body 312 and reach the plant.

For another example, let it be assumed the user is trying to grow strawberries in the pot 316. Some concerns for strawberries are slugs and snails 324, which damage the berries. Upon planting the strawberries and necessary soil in the hollow body 312, the user may fill the trap container 302 with beer, salt, or some other substance known to deter or attract and trap snails or slugs.

In this case, let it be assumed the user elects to deploy beer as the substance 310. When the pest 324 attempts to reach the hollow body 312, it must first necessarily go through the trap container 302 as there are no points of entry into the hollow body 312 below the trap. Furthermore, in some embodiments the vertical gap between the roof element 306 and the exterior wall portion of the trap may be of such a size so that a pest could not extend itself to such a length as to reach the roof without climbing the partition 308 between the hollow body 312 and the trap container 302.

By entering the hollow body 312 and coming into contact with the beer 310 the pest 324 may sustain a process analogous to inebriation, under which it may remain in the trap container 302 and never come out until the time of its expiration/death.

On the other hand, if environmental or other concerns lead the user to elect to use eggshells as the pest-controlling substance 310 rather than beer, the result would be the same except for pest 324 would be deterred or killed by the damaging effects eggshells have upon snails and slugs.

The hollow body 312 would extend to such length below the ground level 313 that the pests 324 would be unlikely to burrow deep enough to go around the hollow body 312 and reach the plant.

For another example, let it be assumed that the user would like to grow some sort of ornamental plant, such as fruitless figs, in the pot 316. Some ornamental plants are at risk of being eaten or damages by woodlice. After planting the plant in the hollow body 312 with the appropriate soil, the user may fill the trap container 302 with diatomaceous earth.

When the pest 324 attempts to reach the hollow body 312, it must first necessarily go through the trap container 302 as there are no points of entry into the hollow body 312 below the trap. Furthermore, in some embodiments the vertical gap between the roof element 306 and the exterior wall portion of the trap may be of such a size so that a pest could not extend itself to such a length as to reach the roof without climbing the partition 308 between the plant container hollow body 312 and the trap container 302. This path is depicted by the reference number “309” in FIG. 3B.

By entering the trap container 302 and coming into contact with the diatomaceous earth 310, the pest 324 must crawl through or over the diatomaceous earth 310, and this will have the result of wearing out its shell. Even if the pest 324 lives long enough to exit the trap container 302 and enter the hollow body 312, the pest 324 will likely die of dehydration shortly thereafter.

The hollow body 312 would extend to such length below the ground level 313 that the pests 324 would be unlikely to burrow deep enough to go around the hollow body 312 and reach the plant.

The use of household items in the trap container 302 as the pest-controlling substance 310 allows for a reduction in damage to the surrounding environment by harmful substances that might otherwise be used as pesticides to protect the plant. This leads to safer conditions for children and domesticated animals by removing the risk of accidental poisoning. The overall use of this pot 316 further reduces the global need for pesticide which reduces the globally harmful byproducts of pesticide production.

The different embodiments of gardening disclosures illustrated in FIGS. 4A-4E will now be described in more detail.

Referring to FIGS. 4A-4D, in some embodiments of a tray 420 made up of a first open-top container for housing a pot 415 and a trap container 402 to house some pest-controlling substance 410 that deters or attracts and traps pests 424. In order to prevent contents of the trap container 402 from mixing with the contents of the first open-top container, the trap container 402 can be coupled to the first open-top container in such a way as to isolate the space inside the first open-top container from the space inside the trap container 402, e.g., via wall or another physical barrier between first open-top container and the open-top container for housing a pot 415.

The trap container 402 may be coupled to the lower portion of the first open-top container, with a roof element 406 extending outward and slightly downward from the open top of the enclosed wall portion 404 of the first open-top container. For the purposes of illustration, one particular type of roof element 406 is discussed, namely a roof element 406 with a consistent, straight surface slanted downward and extending outward from a higher point where the roof element 406 meets the side portion of the open-top container to a lower point where the roof element 406 ends at its point which is the farthest away from the pot 416 center, but extends past the trap container 402.

In some embodiments, also have a floor section 405 for holding the pot 415, the floor section 405 having at least on raised surface 414 adapted to be in contact with the pot 415 when the pot 415 is housed in the first open-top container 401, wherein the raised surface 414 covers only a portion of the floor section 405, so that contents that drain out of the pot 415 into the first open-top container 401 are collected in one or more areas of the floor section 405 not covered by the raised surface.

Generally, the first open-top container 401 includes an open top and an enclosed wall portion 404 that forms an open space (within the perimeter of the enclosed wall portion 404) for housing the plant. The trap container 402 may be coupled to the first open-top container along the perimeter of the enclosed wall portion 404 of the first open top container 401. Generally, a variety of shapes can be used for the first open-top container and the trap container 402, e.g. frusta of cone or pyramids. In the event where the first open-top container and/or the trap container 402 take the shape of a frustum of a pyramid (or frusta of different pyramids), the first open-top container and/or the trap container 402 may have any number of edges or faces, and the different edges and faces can have different lengths and/or areas, respectively. For example, the first open-top container and/or the trap container 402 can be a square, a rectangular, hexagonal frustum, or a frustum with a variety of other bases.

In some embodiments, the trap container 402 is of such a depth that the pest-controlling substance 410 may safely be deployed without fear of being reached by children, domesticated animals, or similar sources of potential disruption of the trap contents, such as raccoons, wind, etc.

Because the enclosed wall portion 404 and the side portion 403 of the trap container 402 will, in many embodiments, have length sufficient to partially enclose some area of space between them, the trap container 402 may be deep enough to allow the pest-controlling substance 410 to act to deter or attract and trap pests 424, while still possibly being deep enough so that children or larger creatures such as domesticated animals would not be able to reach the contents, while most pests 424 such as snails, slugs, ants, and other pests 424, would be of such a small size that they would be able to crawl into where the pest-controlling substance 410 rests and thereby either be deterred by it or be attracted and trapped by it.

The range of depth for the trap container 402 can be from one half of one inch to two feet. The range of distance between the side portion 403 of the trap container 402 and the enclosed wall portion 404 of the first open-top container can be between half of one centimeter to eight centimeters. The range of the vertical gap 417 between the roof element 406 and the exterior wall of the trap container 402 can be from one centimeter to sixteen centimeters.

In the various embodiments of the roof element 406, the roof can be a variety of sizes and lengths, of a variety of thickness, and could extend inward at a variety of angles from the enclosed wall portion 404 of the first open-top container. One of ordinary skill in the art would understand that the roof element 406 could be made in a variety of ways, including a flat or substantially flat roof element 406 extending parallel with the surface below, a “downward slanted” roof element 406 extending from a higher point where the roof element 406 meets the enclosed wall portion 404 of the first open-top container to a lower point where the roof element 406 meets the partition between the trap container 402 and the first open-top container, or an “upward slanted” roof element 406 extending from a lower point where the roof meets the enclosed wall portion 404 of the first open-top container to a higher point where the roof meets the open top of the first open-top container 401.

In various embodiments, the roof element 406 could also include ridges, dots, raised surfaces, some sort of crevices, and otherwise not necessarily be a level surface. One of ordinary skill in the art would understand that the roof could be made in a variety of ways.

The pest-controlling substance 410 can generally be any substance used to deter or attract and trap pests. Additionally, one or a combination of these substances may be household items. For example, assuming that the user is growing a dwarf lemon tree in the pot 415, one concern for the user would be a pest 424 known as scales.

Scales are parasitic, insect-like creatures that sink their appendages into citrus, and other, trees, damaging them. The scales are brought to the citrus trees by ant colonies; they protect the scales and help them grown in order to harvest the sugar-like secretions that the scales expel. In such a situation the user would be concerned about ants reaching his or her lemon tree. In using one of the embodiments of this tray 415, the user might plant the tree with the appropriate amount of soil in the first open-top container and then fill the trap container 402 with ground pepper, or some other substance known to deter ants.

When ants 424 would try to reach the plant in the first open-top container, there would be no point of entry in the pot 416 to the first open-top container that is vertically lower than the trap container 402. Therefore, to reach the plant in the first open-top container the ants 424 would have to climb the side of the trap container 3 and climb into the trap container 402, before climbing up a partition separating the first open-top container and the trap container 402, before proceeding to climb the rest of the first open-top container to reach the plant. This path is depicted by the reference number “409” in FIG. 4C. Once the pest 424 come into contact with the pest-controlling substance 410 in the trap container 402 the pest would be deterred and turn back, without being able to cross to the previously mentioned partition and without being able to reach the first open-top container.

For another example, let it be assumed the user is trying to grow strawberries in the pot 415. Some concerns for strawberries are slugs and snails 424, which damage the berries. Upon planting the strawberries and necessary soil in the first open-top container, the user may fill the trap container 402 with beer, salt, or some other pest-controlling substance 410 known to deter or attract and trap snails or slugs.

In this case, let it be assumed the user elects to deploy beer as the pest-controlling substance 410. When the pest 424 attempts to reach the first open-top container, it must first necessarily go through the trap container 402 as there are no points of entry into the first open-top container below the trap. Furthermore, in some embodiments the vertical gap 417 between the roof element 406 and the side 3 of the trap container 402 may be of such a size so that a pest could not extend itself to such a length as to reach the roof without climbing the partition between the first open-top container and the trap container 402.

By entering the trap container 402 and coming into contact with the beer 10 the pest 424 may sustain a process analogous to inebriation, under which it may remain in the trap container 402 and never come out until the time of its expiration/death.

On the other hand, if environmental or other concerns lead the user to elect to use eggshells as the pest-controlling substance 410, the result would be the same except for the pest or pests 424 would be deterred or killed by the damaging effects eggshells have upon snails and slugs.

For another example, let it be assumed that the user would like to grow some sort of ornamental plant, such as fruitless figs, in the pot 415. Some ornamental plants are at risk of being eaten or damages by woodlice 424. After planting the plant in the first open-top container with the appropriate soil, the user may fill the trap container 402 with diatomaceous earth.

When the pest 424 attempts to reach the first open-top container, it must first necessarily go through the trap container 402 as there are no points of entry into the first open-top container below the trap container 402. Furthermore, in some embodiments the vertical gap between the roof element 406 and the side portion 403 of the trap container 402 may be of such a size so that a pest could not extend itself to such a length as to reach the roof element 406 without climbing the partition 8 between the first open-top container and the trap container 402. This path is depicted by the reference number “409” in FIG. 4C.

By entering the trap container 402 and coming into contact with the diatomaceous earth 410, the pest 424 must crawl through or over the diatomaceous earth 410, and this will have the result of wearing out its shell. Even if the pest 424 lives long enough to exit the trap container 402 and enter the first open-top container, the pest 424 will likely die of dehydration shortly thereafter.

The use of household items in the trap container 402 as the pest-controlling substance 410 allows for a reduction in damage to the surrounding environment by harmful substances that might otherwise be used as pesticides to protect the plant. This leads to safer conditions for children and domesticated animals by removing the risk of accidental poisoning. The overall use of this pot 416 further reduces the global need for pesticide which reduces the globally harmful byproducts of pesticide production.

The tray 420 can be made from various materials. It can be made from plastic, clay, or any other suitable material. One of ordinary skill in the art will understand that various other materials can be used to produce this pot. The various materials can be used to meet a variety of weight, climate, aesthetic, or other considerations, and a change in the device's material components does not affect the utility or use of some of the embodiments.

The tray 420 can be made in a variety of sizes. One of ordinary skill in the art will understand that a variety of sizes are possible without compromising the utility of the tray 420.

The embodiments illustrated in FIGS. 4A-4D may be deployed on any terrain where gardening pots are commonly used, including sidewalks, earth, sand, balconies, wooden decks, etc. One of ordinary skill in the art will understand that a variety of terrains or surfaces are suitable for the embodiments illustrated in FIGS. 4A-4D. The embodiments illustrated in FIGS. 4A-4D may be deployed indoors, outdoors, and to a variety of “in-between” areas such as gazebos, partial enclosures, balconies, canopied decks, etc. One of ordinary skill in the art will understand that there are a variety of places where these embodiments may be deployed.

One distinction of the tray 420 illustrated by FIGS. 4A-4C is that the tray 420 allows a pot 415 to be placed within the open-top container, which allows the user to salvage the previous investments made in pottery while also providing the protective utility of the tray 420 and the trap container 402. Furthermore, the tray 420 allows the user to reap the benefits of the protective utility of the tray 420 and trap container 402 without having to transfer plants already in pots 415 out of the pots 415 and into new pots, such as those illustrated by FIGS. 1A-1E, 2A-2D, and 3A-3E.

While multilane gardening enclosures have been described with reference to specific examples, which are intended to be illustrative only and not to be limiting of the disclosure, it is noted that changes, additions and/or deletions may be made to the disclosed embodiments without departing from the spirit and scope of the disclosure. The scope of the disclosure is therefore not covered by any specific embodiment, but rather by the following claims.

What is claimed is:

1. A pot comprising:
a first open-top container forming a first open space for housing a plant, the first open-top container comprising an open top and an enclosed wall portion, the enclosed wall portion forming a lateral perimeter of the first open-top container; and
a second open-top container forming a second open space for housing a pest-controlling substance that deters or attracts and traps pests, wherein the second open-top container is coupled to the first open-top container along the lateral perimeter of the first open-top container, and wherein the first open space is isolated from the second open space to prevent contents in the first open space from mixing with contents from the second open space.

2. The pot of claim 1, further comprising a roof element coupled to the first open-top container along the lateral perimeter of the first open-top container and positioned above the second open-top container to limit entry of substances other than the pest-controlling substance into the second open-top container.

3. The pot of claim 2, wherein the roof element extends inward and upward from the enclosed wall portion of the first open-top container.

4. The pot of claim 2, wherein the roof element extends outward and downward from the enclosed wall portion of the first open-top container.

5. The pot of claim 2, wherein the roof element extends outward and downward from the open top of the first open-top container.

6. The pot of claim 2, wherein the first open-top container includes a drainage system comprising at least one opening in the enclosed wall portion of the first open-top container to allow at least some contents of the first open-top container to drain out of the first open-top container via the at least one opening, and wherein the drainage system is positioned above the roof element to limit entry into the second open-top container of contents draining out of the first open-top container.

7. The pot of claim 2, wherein a vertical gap between the second open-top container and the roof element is between one (1) and sixteen (16) centimeters.

8. The pot of claim 1, wherein the second open-top container is coupled to the first open-top container such that at least a portion of the first open-top container and at least a portion of the second open-top container together outline a frustum of a cone or a pyramid for stackability.

9. The pot of claim 1, wherein the second open-top container is coupled to the first open-top container near the open top of the first open-top container.

10. A pot comprising:
a hollow body forming a first open space forming a first open space for housing a plant, the hollow body comprising an enclosed wall portion, the enclosed wall portion forming a lateral perimeter of the hollow body; and
an open-top container forming a second open space for housing a pest-controlling substance that deters or attracts and traps pests, wherein the open-top container is coupled to the hollow body along the lateral perimeter of the hollow body, and wherein the first open space is isolated from the second open space to prevent contents in the first open space from mixing with contents from the second open space.

11. The pot of claim 10, further comprising a roof element coupled to the hollow body above the open-top container to limit entry of substances other than the pest-controlling substance into the open-top container.

12. The pot of claim 11, wherein the roof element extends inward and upward from the enclosed wall portion of the hollow body, and wherein the open-top container extends inward from the enclosed wall portion of the hollow body.

13. The pot of claim 11, wherein the first open-top container includes a drainage system comprising at least one opening in the enclosed wall portion of the first open-top container to allow at least some contents of the first open-top container to drain out of the first open-top container via the at least one opening, and wherein the drainage system is positioned above the roof element to limit entry into the second open-top container of contents draining out of the first open-top container.

14. The pot of claim 10, wherein the open-top container is coupled to the hollow body such that at least a portion of the hollow body and at least a portion of the open-top container together outline a frustum of a cone or a pyramid for stackability.

15. The pot of claim 10, wherein a vertical gap between the second open-top container and the roof element is between one (1) and sixteen (16) centimeters.

16. A tray for housing a plant pot, the tray comprising:
a first open-top container forming a first open space for housing a pot, the first open-top container comprising an open top and an enclosed wall portion, the enclosed wall portion forming a lateral perimeter of the first open-top container; and
a second open-top container forming a second open space for housing a pest-controlling substance that deters or attracts and traps pests, wherein the second open-top container is coupled to the first open-top container along the lateral perimeter of the first open-top container, and wherein the first open space is isolated from the second open space to prevent contents in the first open space from mixing with contents from the second open space.

17. The tray of claim 16, further comprising a roof element coupled to the first open-top container along the lateral perimeter of the first open-top container and positioned above the second open-top container to limit entry of substances other than the pest-controlling substance into the second open-top container.

18. The tray of claim 17, wherein the roof element extends outward and downward from the enclosed wall portion of the first open-top container.

19. The tray of claim 17, wherein a vertical gap between the second open-top container and the roof element is between one (1) and sixteen (16) centimeters.

20. The tray of claim 16, wherein the first open-top container includes a floor section for holding the pot, the floor section having at least on raised surface adapted to be in contact with the pot when the pot is housed in the first open-top container, wherein the raised surface covers only a portion of the floor section, such that contents that drain out of the pot into the first open-top container are collected in one or more areas of the floor section not covered by the raised surface.
